(19) United States
(12) Patent Application Publication
(10) Pub. No.: US 2021/0329892 A1
(43) Pub. Date: Oct. 28, 2021

(54) DYNAMIC FARM SENSOR SYSTEM RECONFIGURATION

(71) Applicant: Ecto, Inc., Atlanta, GA (US)

(72) Inventors: Dmitry Kozachenok, Atlanta, GA (US); Allen Torng, Atlanta, GA (US)

(21) Appl. No.: 16/858,769

(22) Filed: Apr. 27, 2020

(51) Int. Cl. A01K 61/60; A01K 61/80; E02B 17/00

(52) U.S. Cl. CPC A01K 61/60; E02B 17/00; A01K 61/80

(57) ABSTRACT

A method of dynamically reconfiguring sensor system operating parameter by receiving, at an electronic device, data indicative of one or more underwater object parameters corresponding to one or more underwater objects within a marine enclosure. A set of intrinsic operating parameters for a sensor system at a position within the marine enclosure is determined based at least in part on the data indicative of one or more underwater object parameters. The sensor system is configured according to the determined set of intrinsic operating parameters by changing at least one intrinsic operating parameter of the sensor system in response to the data indicative of one or more underwater object parameters.

### BACKGROUND

Industrial food production is increasingly important in supporting population growth world-wide and the changing diets of consumers, such as the move from diets largely based on staple crops to diets that include substantial amounts of animal, fruit, and vegetable products. Precision farming technologies help increase the productivity and efficiency of farming operations by enabling farmers to better respond to spatial and temporal variabilities in farming conditions. Precision farming uses data collected by various sensor systems to enhance production systems and optimize farming operations, thereby increasing the overall quality and quantity of farmed products.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a system for implementing dynamic reconfiguration of sensor system operating parameters in accordance with some embodiments.

FIG. 2 is a diagram illustrating a system for implementing dynamic reconfiguration of image sensor operating parameters in accordance with some embodiments.

FIG. 3 is a diagram illustrating an example of dynamic reconfiguration of image sensor operating parameters in accordance with some embodiments.

FIG. 4 is a diagram illustrating a sensor system for implementing dynamic reconfiguration of acoustic sensor operating parameters in accordance with some embodiments.

FIG. 5 is a diagram illustrating an example of dynamic reconfiguration of acoustic sensor operating parameters in accordance with some embodiments.

FIG. 6 is a flow diagram of a method for implementing dynamic reconfiguration of sensor operating parameters in accordance with some embodiments.

FIG. 7 is a block diagram illustrating a system configured to provide dynamic reconfiguration of sensor operating parameters in accordance with some embodiments.

### DETAILED DESCRIPTION

Farm operators in husbandry, including cultivation or production in agriculture and aquaculture industries, often deploy precision farming techniques including various sensor systems to help farmers monitor farm operations and to keep up with changing environmental factors. Observation sensors may allow a farmer the ability to identify individual animals, track movements, and other behaviors for managing farm operations. However, farm operators face several challenges in observing and recording data related to farm operations by nature of the environments in which husbandry efforts are practiced.

Aquaculture (which typically refers to the cultivation of fish, shellfish, and other aquatic species through husbandry efforts) is commonly practiced in open, outdoor environments and therefore exposes farmed animals, farm staff, and farming equipment to factors that are, at least partially, beyond the control of operators. Such factors include, for example, variable and severe weather conditions, changes to water conditions, turbidity, interference with farm operations from predators, and the like. Further, aquaculture stock is often held underwater and therefore more difficult to observe than animals and plants cultured on land. Conventional sensor systems are therefore associated with several limitations including decreased accessibility during certain times of the day or during adverse weather conditions.

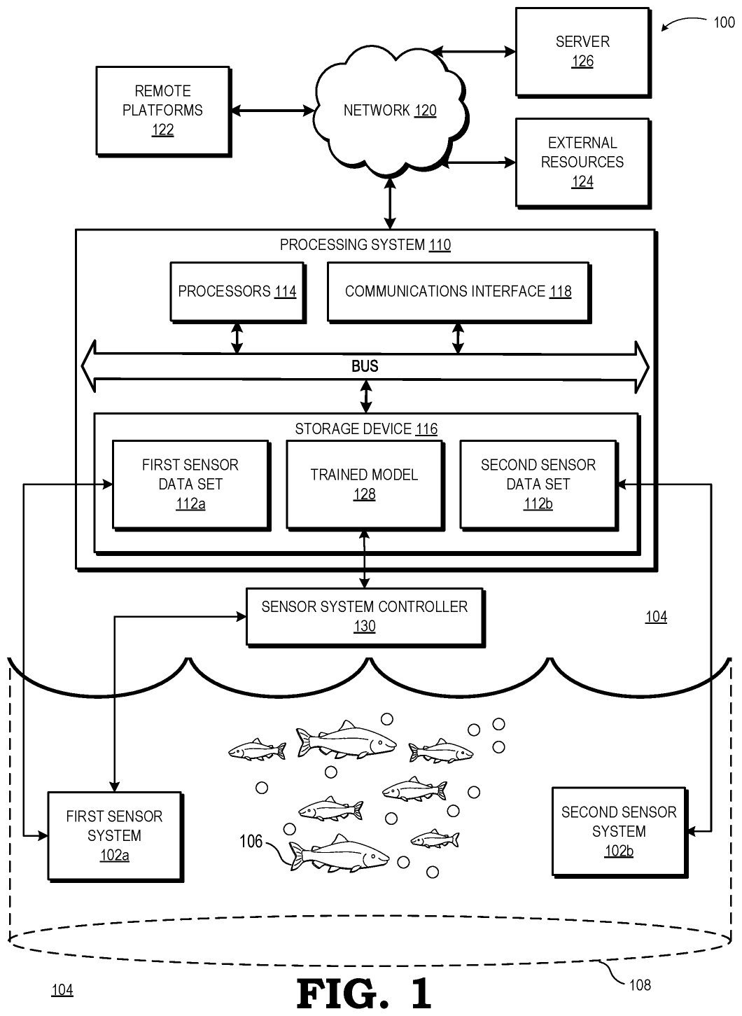

To improve the precision and accuracy of sensor system measurements, FIGS. 1-7 describe techniques for utilizing dynamic reconfiguration of sensor system operating parameters during operations. In various embodiments, methods of dynamically reconfiguring sensor system operating parameter include receiving, at an electronic device, data indicative of one or more underwater object parameters corresponding to one or more underwater objects within a marine enclosure. A set of intrinsic operating parameters for a sensor system at a position within the marine enclosure is determined based at least in part on the data indicative of one or more underwater object parameters. The sensor system is configured according to the determined set of intrinsic operating parameters by changing at least one intrinsic operating parameter of the sensor system in response to the data indicative of one or more underwater object parameters.

Accordingly, as discussed herein, FIGS. 1-7 describe techniques that improve the precision and accuracy of sensor measurements by dynamically reconfiguring of sensor system operating parameters during operations. In various embodiments, through the use of machine-learning techniques and neural networks, the systems described herein generate learned models that are unique to one or more intended use cases corresponding to different applications or activities at a farm site. Based on sensor data, the systems may use observed conditions at the farm sites to respond to environmental conditions/fish behavior relative to the sensors and adjust sensor intrinsic operating parameters so that obtained sensor measurements are of improved quality (which is dependent upon the particular use cases) without requiring physical repositioning of sensors.

FIG. 1 is a diagram of a system 100 for implementing dynamic reconfiguration of sensor systems in accordance with some embodiments. In various embodiments, the system 100 includes one or more sensor systems 102 that are each configured to monitor and generate data associated with the environment 104 within which they are placed. In general, the one or more sensor systems 102 measure and convert physical parameters such as, for example, moisture, heat, motion, light levels, and the like to analog electrical signals and/or digital data.

As shown, the one or more sensor systems 102 includes a first sensor system 102a for monitoring the environment 104 below the water surface. In particular, the first sensor system 102a is positioned for monitoring underwater objects (e.g., a population of fish 106 as illustrated in FIG. 1) within or proximate to a marine enclosure 108. In various embodiments, the marine enclosure 108 includes a net pen system, a sea cage, a fish tank, and the like. Such marine enclosures 108 may include a circular-shaped base with a cylindrical structure extending from the circular-shaped base to a ring-shaped structure positioned at a water line, which may be approximately level with a top surface of the water surface.

In general, various configurations of an enclosure system may be used without departing from the scope of this disclosure. For example, although the marine enclosure 108 is illustrated as having a circular base and cylindrical body structure, other shapes and sizes, such as rectangular, conical, triangular, pyramidal, or various cubic shapes may also be used without departing from the scope of this disclosure. Additionally, the marine enclosure 108 in various embodiments is constructed of any suitable material, including synthetic materials such as nylon, steel, glass, concrete, plastics, acrylics, alloys, and any combinations thereof.

Although primarily illustrated and discussed here in the context of fish being positioned in an open water environment (which will also include a marine enclosure 108 of some kind to prevent escape of fish into the open ocean), those skilled in the art will recognize that the techniques described herein may similarly be applied to any type of aquatic farming environment and their respective enclosures. For example, such aquatic farming environments may include, by way of non-limiting example, lakes, ponds, open seas, recirculation aquaculture systems (RAS) to provide for closed systems, raceways, indoor tanks, outdoor tanks, and the like. Similarly, in various embodiments, the marine enclosure 108 may be implemented within various marine water conditions, including fresh water, sea water, pond water, and may further include one or more species of aquatic organisms.

As used herein, it should be appreciated that an underwater “object” refers to any stationary, semi-stationary, or moving object, item, area, or environment in which it may be desirable for the various sensor systems described herein to acquire or otherwise capture data of. For example, an object may include, but is not limited to, one or more fish 106, crustacean, feed pellets, predatory animals, and the like. However, it should be appreciated that the sensor measurement acquisition and analysis systems disclosed herein may acquire and/or analyze sensor data regarding any desired or suitable “object” in accordance with operations of the systems as disclosed herein. Further, it should be recognized that although specific sensors are described below for illustrative purposes, various sensor systems may be implemented in the systems described herein without departing from the scope of this disclosure.

In various embodiments, the first sensor system 102a includes one or more observation sensors configured to observe underwater objects and capture measurements associated with one or more underwater object parameters. Underwater object parameters, in various embodiments, include one or more parameters corresponding to observations associated with (or any characteristic that may be utilized in defining or characterizing) one or more underwater objects within the marine enclosure 108. Such parameters may include, without limitation, physical quantities which describe physical attributes, dimensioned and dimensionless properties, discrete biological entities that may be assigned a value, any value that describes a system or system components, time and location data associated with sensor system measurements, and the like.

For ease of illustration and description, FIG. 1 is described here in the context of underwater objects including one or more fish 106. However, those skilled in the art will appreciate that the marine enclosure 108 may include any number of types and individual units of underwater objects. For embodiments in which the underwater objects include one or more fish 106, an underwater object parameter includes one or more parameters characterizing individual fish 106 and/or an aggregation of two or more fish 106. As will be appreciated, fish 106 do not remain stationary within the marine enclosure 108 for extended periods of time while awake and will exhibit variable behaviors such as swim speed, schooling patterns, positional changes within the marine enclosure 108, density of biomass within the water column of the marine enclosure 108, size-dependent swimming depths, food anticipatory behaviors, and the like.

In some embodiments, an underwater object parameter with respect to an individual fish 106 encompasses various individualized data including but not limited to: an identification (ID) associated with an individual fish 106, movement pattern of that individual fish 106, swim speed of that individual fish 106, health status of that individual fish 106, distance of that individual fish 106 from a particular underwater location, and the like. In some embodiments, an underwater object parameter with respect to two or more fish 106 encompasses various group descriptive data including but not limited to: schooling behavior of the fish 106, average swim speed of the fish 106, swimming pattern of the fish 106, physical distribution of the fish 106 within the marine enclosure 108, and the like.

A processing system 110 receives data generated by the one or more sensor systems 102 (e.g., sensor data sets 112) for storage, processing, and the like. As shown, the one or more sensor systems 102 includes a first sensor system 102a having one or more sensors configured to monitor underwater objects and generate data associated with at least a first underwater object parameter. Accordingly, in various embodiments, the first sensor system 102a generates a first sensor data set 112a and communicates the first sensor data set 112a to the processing system 110. In various embodiments, the one or more sensor systems 102 includes a second sensor system 102b positioned proximate the marine enclosure 108 and configured to monitor the environment 104 within which one or more sensors of the second sensor system 102b are positioned. Similarly, the second sensor system 102b generates a second sensor data set 112b and communicates the second sensor data set 112 to the processing system 110.

In some embodiments, the one or more sensors of the second sensor system 102b are configured to monitor the environment 104 below the water surface and generate data associated with an environmental parameter. In particular, the second sensor system 102b of FIG. 1 includes one or more environmental sensors configured to capture measurements associated with the environment 104 within which the system 100 is deployed. In various embodiments, the environmental sensors of the second sensor system 102b include one or more of a turbidity sensor, a pressure sensor, a dissolved oxygen sensor, an ambient light sensor, a temperature sensor, a salinity sensor, an optical sensor, a motion sensor, a current sensor, and the like. For example, in one embodiment, the environmental sensors of the second sensor system 102b includes a turbidity sensor configured to measure an amount of light scattered by suspended solids in the water. Turbidity is a measure of the degree to which water (or other liquids) changes in level of its transparency due to the presence of suspended particulates (e.g., by measuring an amount of light transmitted through the water). As described in further detail below, in various embodiments, the environmental sensors of the second sensor system 102b generate environmental data that serves as reference data for implementing the dynamic reconfiguration of sensor system operating parameters.

In various embodiments, the one or more sensor systems 102 is communicably coupled to the processing system 110 via physical cables (not shown) by which data (e.g., sensor data sets 112) is communicably transmitted from the one or more sensor systems 102 to the processing system 110. Similarly, the processing system 110 is capable of communicably transmitting data and instructions via the physical cables to the one or more sensor systems 102 for directing or controlling sensor system operations. In other embodiments, the processing system 110 receives one or more of the sensor data sets 112 (e.g., first sensor data set 112a and the environmental sensor data set 112b) via, for example, wired-telemetry, wireless-telemetry, or any other communications link for processing, storage, and the like.

The processing system 110 includes one or more processors 114 coupled with a communications bus (not shown) for processing information. In various embodiments, the one or more processors 114 include, for example, one or more general purpose microprocessors or other hardware processors. By way of non-limiting example, in various embodiments, the processing system 110 may be any computer system, such as a workstation, desktop computer, server, laptop, handheld computer, tablet computer, mobile computing or communication device, or other form of computing or telecommunications device that is capable of communication and that has sufficient processor power and memory capacity to perform the operations described herein.

The processing system 110 also includes one or more storage devices 116 communicably coupled to the communications bus for storing information and instructions. In some embodiments, the one or more storage devices 116 includes a magnetic disk, optical disk, or USB thumb drive, and the like for storing information and instructions. In various embodiments, the one or more storage devices 116 also includes a main memory, such as a random-access memory (RAM), cache and/or other dynamic storage devices, coupled to the communications bus for storing information and instructions to be executed by the one or more processors 114. The main memory may be used for storing temporary variables or other intermediate information during execution of instructions to be executed by the one or more processors 114. Such instructions, when stored in storage media accessible by the one or more processors 114, render the processing system 110 into a special-purpose machine that is customized to perform the operations specified in the instructions.

The processing system 110 also includes a communications interface 118 communicably coupled to the communications bus. The communications interface 118 provides a multi-way data communication coupling configured to send and receive electrical, electromagnetic or optical signals that carry digital data streams representing various types of information. In various embodiments, the communications interface 118 provides data communication to other data devices via, for example, a network 120.

Users may access system 100 via remote platform(s) 122. For example, in some embodiments, the processing system 110 may be configured to communicate with one or more remote platforms 122 according to a client/server architecture, a peer-to-peer architecture, and/or other architectures via the network 120. The network 120 may include and implement any commonly defined network architecture including those defined by standard bodies. Further, in some embodiments, the network 120 may include a cloud system that provides Internet connectivity and other network-related functions. Remote platform(s) 122 may be configured to communicate with other remote platforms via the processing system 110 and/or according to a client/server architecture, a peer-to-peer architecture, and/or other architectures via the network 120.

A given remote platform 122 may include one or more processors configured to execute computer program modules. The computer program modules may be configured to enable a user associated with the given remote platform 122 to interface with system 100, external resources 124, and/or provide other functionality attributed herein to remote platform(s) 122. External resources 124 may include sources of information outside of system 100, external entities participating with system 100, and/or other resources. In some implementations, some or all of the functionality attributed herein to external resources 124 may be provided by resources included in system 100.

In some embodiments, the processing system 110, remote platform(s) 122, and/or one or more external resources 124 may be operatively linked via one or more electronic communication links. For example, such electronic communication links may be established, at least in part, via the network 120. It will be appreciated that this is not intended to be limiting, and that the scope of this disclosure includes implementations in which the processing system 110, remote platform(s) 122, and/or external resources 124 may be operatively linked via some other communication media. Further, in various embodiments, the processing system 110 is configured to send messages and receive data, including program code, through the network 120, a network link (not shown), and the communications interface 118. For example, a server 126 may be configured to transmit or receive a requested code for an application program through via the network 120, with the received code being executed by the one or more processors 114 as it is received, and/or stored in storage device 116 (or other non-volatile storage) for later execution.

As previously described, the processing system 110 receives one or more sensor data sets 112 (e.g., first sensor data set 112a and the environmental sensor data set 112b) and stores the sensor data sets 112 at the storage device 116 for processing. In various embodiments, the sensor data sets 112 include data indicative of one or more conditions at one or more locations at which their respective sensor systems 102 are positioned. In some embodiments, the first sensor data set 112a includes sensor data indicative of, for example, movement of one or more objects, orientation of one or more objects, swimming pattern or swimming behavior of one or more objects, jumping pattern or jumping behavior of one or more objects, any activity or behavior of one or more objects, any underwater object parameter, and the like. In some embodiments, the environmental data set 112b includes environmental data indicating environmental conditions such as, for example, an ambient light level, an amount of dissolved oxygen in water, a water temperature level, a direction of current, a strength of current, a salinity level, a water turbidity, a water pressure level, a topology of a location, a weather forecast, and the like.

As will be appreciated, environmental conditions will vary over time within the relatively uncontrolled environment within which the marine enclosure 108 is positioned. Further, fish 106 freely move about and change their positioning and/or distribution within the water column (e.g., both vertically as a function of depth and horizontally) bounded by the marine enclosure 108 due to, for example, time of day, schooling patterns, resting periods, feeding periods associated with hunger, and the like. Accordingly, in various embodiments, the system 100 dynamically reconfigures operating parameters of the one or more sensor systems 102 during operations, based at least in part on measured underwater object parameters and/or environmental conditions, and adapt sensor system 102 operations to the varying physical conditions of the environment 104 and/or the fish 106. In this manner, the one or more sensor systems 102 may be dynamically reconfigured to change its operating parameters for improving the quality of sensor measurements without requiring a change in the physical location of the sensor systems 102. This is particularly beneficial for stationary sensor systems 102 without repositioning capabilities or for reducing disadvantages associated with physically repositionable sensors (e.g., more moving parts that increase possibilities of equipment malfunctions, disturbing the fish 106 which may negatively impact welfare and increase stress, and the like).

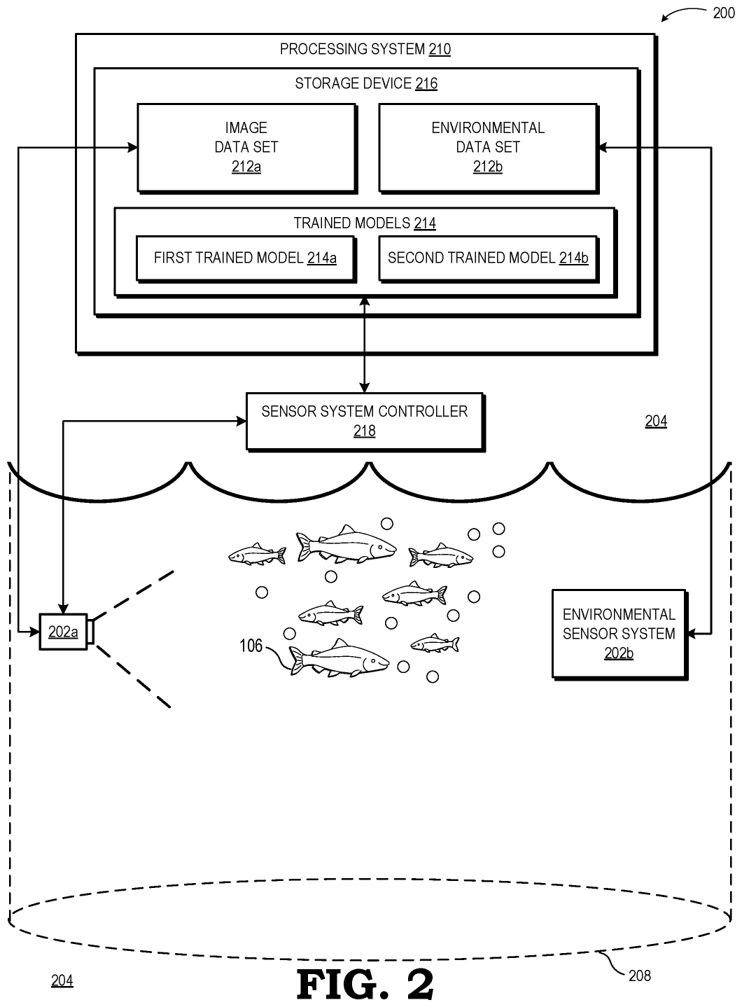

As described in more detail below with respect to FIGS. 2-7, the processing system 110 provides at least a portion of the sensor data 112 corresponding to underwater object parameters (e.g., first sensor data set 112a) and environmental conditions (e.g., environmental sensor data set 112b) as training data for generating a trained model 128 using machine learning techniques and neural networks. One or more components of the system 100, such as the processor 110 and a sensor system controller 130, may be periodically trained to improve the performance and reliability of sensor system 102 measurements.

In particular, sensor systems may be reconfigured in response to commands received from a computer system (e.g., processing system 110) for providing an efficient manner for automated and dynamic monitoring of fish to improve the results of aquaculture operations, including feeding observations and health monitoring. In various embodiments described herein, the dynamic sensor reconfiguration of intrinsic operating parameters is customized for particular activities. For example, in one embodiment, obtained images from image sensors is used to monitor conditions in marine enclosures and identify hunger levels based on swimming patterns or locations within the marine enclosure. A feed controller may be turned on or off (or feeding rates ramped up or down) based on image-identified behaviors to reduce over- and under-feeding.

As will be appreciated, feeding-related use cases require images of different properties than, for example, another embodiment in which images are used to monitor track fish individuals and/or fish health by identifying and counting lice on each individual fish. Lice counting will generally require a higher resolution image in which more pixels are dedicated to each individual fish, something that would lose context of overall fish behavior and position within the marine enclosure (and therefore be bad quality data) if used in feeding applications. Additionally, because the sensors are capturing more relevant data for its intended uses, the dynamic reconfiguring of sensor system operating parameters during operations improves efficiency for computer, storage, and network resources. This is particularly evident in the resource-constrained environments of aquaculture operations, which are often compute limited and further exhibit network bandwidth constraints or intermittent connectivity due to the remote locales of the farms.

Referring now to FIG. 2, illustrated is a diagram showing a system 200 implementing dynamic reconfiguration of image sensor systems in accordance with some embodiments. In various embodiments, the system 200 includes one or more sensor systems 202 that are each configured to monitor and generate data associated with the environment 204 within which they are placed. In general, the one or more sensor systems 202 measure and convert physical parameters such as, for example, moisture, heat, motion, light levels, and the like to analog electrical signals and/or digital data.

As shown, the one or more sensor systems 202 includes a first image sensor system 202a including one or more cameras configured to capture still images and/or record moving images (e.g., video data). The one or more cameras may include, for example, one or more video cameras, photographic cameras, stereo cameras, or other optical sensing devices configured to capture imagery periodically or continuously. The one or more cameras are directed towards the surrounding environment 204, with each camera capturing a sequence of images (e.g., video frames) of the environment 204 and any objects in the environment.

In various embodiments, the one or more cameras of the first image sensor system 202a are configured to capture image data corresponding to, for example, the presence (or absence), abundance, distribution, size, and behavior of underwater objects (e.g., a population of fish 206 within a marine enclosure 208 as illustrated in FIG. 2). The system 200 may be used to monitor an individual fish, multiple fish, or an entire population of fish within the marine enclosure 208. Such image data measurements may, for example, be used to identify fish positions within the water. It should be recognized that although specific sensors are described below for illustrative purposes, various imaging sensors may be implemented in the systems described herein without departing from the scope of this disclosure.

In various embodiments, each camera (or lens) of the one or more cameras of the first image sensor system 202a has a different viewpoint or pose (i.e., location and orientation) with respect to the environment. Although FIG. 2 only shows a single camera for ease of illustration and description, persons of ordinary skill in the art having benefit of the present disclosure should appreciate that the first image sensor system 202a can include any number of cameras (or lenses) and which may account for parameters such as each camera's horizontal field of view, vertical field of view, and the like. Further, persons of ordinary skill in the art having benefit of the present disclosure should appreciate that the first image sensor system 202a can include any arrangement of cameras (e.g., cameras positioned on different planes relative to each other, single-plane arrangements, spherical configurations, and the like).

In some embodiments, the imaging sensors of the first image sensor system 202a includes a first camera (or lens) having a particular field of view as represented by the dashed lines that define the outer edges of the camera's field of view that images the environment 204 or at least a portion thereof. For the sake of clarity, only the field of view for a single camera is illustrated in FIG. 2. In various embodiments, the imaging sensors of the first image sensor system 202a includes at least a second camera having a different but overlapping field of view (not shown) relative to the first camera (or lens). Images from the two cameras therefore form a stereoscopic pair for providing a stereoscopic view of objects in the overlapping field of view. Further, it should be recognized that the overlapping field of view is not restricted to being shared between only two cameras. For example, at least a portion of the field of view of the first camera of the first image sensor system 202a may, in some embodiments, overlap with the fields of view of two other cameras to form an overlapping field of view with three different perspectives of the environment 204.

In some embodiments, the imaging sensors of the first image sensor system 202a includes one or more light field cameras configured to capture light field data emanating from the surrounding environment 204. In other words, the one or more light field cameras captures data not only with respect to the intensity of light in a scene (e.g., the light field camera's field of view/perspective of the environment) but also the directions of light rays traveling in space. In contrast, conventional cameras generally record only light intensity data. In other embodiments, the imaging sensors of the first image sensor system 202a includes one or more range imaging cameras (e.g., time-of-flight and LIDAR cameras) configured to determine distances between the camera and the subject for each pixel of captured images. For example, such range imaging cameras may include an illumination unit (e.g., some artificial light source) to illuminate the scene and an image sensor with each pixel measuring the amount of time light has taken to travel from the illumination unit to objects in the scene and then back to the image sensor of the range imaging camera.

It should be noted that the various operations are described here in the context of multi-camera configurations or multi-lens cameras. However, it should be recognized that the operations described herein may similarly be implemented with any type of imaging sensor without departing from the scope of this disclosure. For example, in various embodiments, the imaging sensors of the first image sensor system 202a may include, but are not limited to, any of a number of types of optical cameras (e.g., RGB and infrared), thermal cameras, range- and distance-finding cameras (e.g., based on acoustics, laser, radar, and the like), stereo cameras, structured light cameras, ToF cameras, CCD-based cameras, CMOS-based cameras, machine vision systems, light curtains, multi- and hyper-spectral cameras, thermal cameras, and the like. Such imaging sensors of the first image sensor system 202a may be configured to capture, single, static images and/or also video images in which multiple images may be periodically captured. In some embodiments, the first image sensor system 202a may activate one or more integrated or external illuminators (not shown) to improve image quality when ambient light conditions are deficient (e.g., as determined by luminosity levels measured by, for example, a light sensor falling below a predetermined threshold).

Additionally, as illustrated in FIG. 2, the one or more sensor systems 202 includes a second sensor system 202b positioned below the water surface and including a second set of one or more sensors. In various embodiments, the second set of one or more sensors include one or more environmental sensors configured to monitor the environment 204 below the water surface and generate data indicative of one or more environmental conditions associated with the marine enclosure 208. Although the second sensor system 202b is shown in FIG. 2 to be positioned below the water surface, those skilled in the art will recognize that one or more of the environmental sensors of the second sensor system 202b may be deployed under the water surface, at the water surface, above the water surface, remote to the locale at which the fish 206 are located, remote to the processing system 210, or any combination of the above without departing from the scope of this disclosure.

In various embodiments, the second sensor system 202b of FIG. 2 includes one or more environmental sensors configured to capture measurements associated with the environment 204 within which the system 200 is deployed. As described in further detail below, in various embodiments, the environmental sensors of the second sensor system 202b generate environmental data that serves as reference data for implementing the dynamic reconfiguration of sensor system operating parameters. Such environmental data may include any measurement representative of the environment 204 within which the environmental sensors are deployed.

For example, in various embodiments, the environmental data (and any data sets corresponding to the environmental data) may include, but is not limited to, any of a plurality of water turbidity measurements, water temperature measurements, metocean measurements, weather forecasts, air temperature, dissolved oxygen, current direction, current speeds, and the like. Further, the environmental parameters and environmental data may include any combination of present, past, and future (e.g., forecasts) measurements of meteorological parameters (e.g., temperature, wind speed, wind direction), water environment parameters (e.g., water temperature, current speed, current direction, dissolved oxygen levels, turbidity levels), air environment parameters, other environmental parameters, and the like. It should be recognized that although specific environmental sensors are described here for illustrative purposes, the second sensor system 202b may include any number of and any combination of various environmental sensors without departing from the scope of this disclosure.

In various embodiments, the processing system 210 receives one or more data sets 212 (e.g., image data set 212a and environmental data set 212b) and stores the data sets 212 at the storage device 216 for processing. In various embodiments, the data sets 212 include data indicative of one or more conditions at one or more locations at which their respective sensor systems 202 are positioned. For example, in some embodiments, the image data set 212a includes image data representing any image-related value or other measurable factor/characteristic that is representative of at least a portion of a data set that describes the presence (or absence), abundance, distribution, size, and/or behavior of underwater objects (e.g., a population of fish 206 as illustrated in FIG. 2). With respect to image data, the image data set 212a may also include camera images capturing measurements representative of the relative and/or absolute locations of individual fish of the population of fish 206 within the environment 204. Such image data may be indicative of one or more underwater object parameters corresponding to one or more underwater objects (e.g., fish 206) within a marine enclosure 208. The image data may be indicative of, for example, movement of one or more objects, orientation of one or more objects, swimming pattern or swimming behavior of one or more objects, jumping pattern or jumping behavior of one or more objects, any activity or behavior of one or more objects, and the like.

It should be recognized that although the underwater object parameter has been abstracted and described here generally as “image data” for ease of description, those skilled in the art will understand that image data (and therefore the image data set 212a corresponding to the image data) may also include, but is not limited to, any of a plurality of image frames, extrinsic parameters defining the location and orientation of the image sensors, intrinsic parameters that allow a mapping between camera coordinates and pixel coordinates in an image frame, camera models, data corresponding to operational parameters of the image sensors (e.g., shutter speed), depth maps, and the like.

In some embodiments, the environmental data set 212b includes environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosure 208. For example, in some embodiments, the environmental sensors of the second sensor system 202b includes an ambient light sensor or other photodetector configured to sense or otherwise measure an amount of ambient light present within the environment local to the sensor. In various embodiments, the environmental sensors of the second sensor system 202b includes a turbidity sensor configured to measure an amount of light scattered by suspended solids in the water. Turbidity is a measure of the degree to which water (or other liquids) changes in level of its transparency due to the presence of suspended particulates (e.g., by measuring an amount of light transmitted through the water). In general, the more total suspended particulates or solids in water, the higher the turbidity and therefore murkier the water appears.

As will be appreciated, variable parameters corresponding to variance in underwater conditions in the environment 204 include, for example, variance in underwater object parameters (e.g., physical location of fish 206 within the marine enclosure 208 such as represented within image data set 212a) and variance in environmental parameters (e.g., the turbidity of a liquid medium such as represented within environmental data set 212b). Underwater conditions often vary and the accuracy of data gathered by different sensor systems will also vary over time. For example, water quality can greatly influence aquaculture facilities located in the near coastal marine environment. Due to biotic and abiotic factors, these coastal settings exhibit large variability in turbidity or clarity throughout the water column. Similarly, the positions and distribution of fish 206 within the marine enclosure 208 will vary over time due to, for example, swimming pattern changes resulting from environmental factors such as temperature, lighting, and water currents, and timings of fish activities related to schooling, feeding, resting, and the like.

Accurate image scene parsing is a crucial component for perception-related tasks in aquaculture. However, the variability of underwater objects and/or the environment will affect the accuracy of image-based measurements and accordingly the accuracy or reliability of any subsequent processes related to the image-based measurements (including human-based observations and assessments, machine-based processes which may consume the image data/image-based measurements as input, and the like). Accordingly, in various embodiments, image data (which in various embodiments includes at least a subset of image data captured by one or more cameras of the first image sensor system 202a) and environmental data (which in various embodiments includes at least a subset of environmental data captured by one or more environmental sensors of the second sensor system 202b) is provided as training data to generate trained models 214 using machine learning techniques and neural networks.

In various embodiments, the training data includes various images of underwater objects (e.g., fish 206) that are annotated or otherwise labeled with label instances (e.g., bounding boxes, polygons, semantic segmentations, instance segmentations, and the like) that identify, for example, individual fish, parasites in contact with the fish, feed pellets in the water, and various other identifiable features within imagery. For example, the training data may include various images of views of the underwater environment 204 and/or various images of fish 206, such as images of fish having varying features and properties, such as fins, tails, shape, size, color, and the like. The training data may also include images with variations in the locations and orientations of fish within each image, including images of the fish captured at various camera viewing angles. Further, in various embodiments, the training data also includes contextual image data (e.g., provided as image metadata) indicating, for example, one or more of lighting conditions, temperature conditions, camera locations, topology of the determined area, current direction or strength, salinity levels, oxygen levels, fish activities, and timing data at the time an image was captured.

Image data is often inhomogeneous due to, for example, variations in the image acquisition conditions due to illumination conditions, different viewing angles, and the like, which can lead to very different image properties such that such that objects of the same class may look very different. For example, in some embodiments, image variations arise due to viewpoint variations in which a single instance of an object can be oriented in various positions with respect to the camera. In some embodiments, image variations arise due to scale variations because objects in visual classes often exhibit variation in their size (i.e., not only in terms of their extent within an image, but the size of objects in the real world). In other embodiments, image variations arise due to deformation as various objects in visual classes are not rigid bodies and can be deformed in various manners. Further, in various embodiments, occlusions occur as objects of interest become positioned in space behind other objects such that they are not within the field of view of a camera and only a portion of an object is captured as pixel data.

Due to one or more of the variations discussed above, the degree of self-similarity between objects may often be quite low (referred to herein as intra-image variability) even within a single image. Similarly, image variations may also occur between different images of one class (referred to herein as intra-class variability). It is desirable to minimize intra-class variability as we want two objects of the same class to look quantitatively similar to a deep learning model. Further, in the context of underwater objects including the population of fish 206, it is desirable to increase inter-class variability such that images containing different species of fish to look different to a trained model, since they are in different categories/classes even though they are still fish.

Underwater image data, which is often captured in uncontrolled nature environments 204, is subject to large intra-class variation due to, for example, changing illumination conditions as the sun moves during the course of a day, changing fish 206 positions as they swim throughout the marine enclosure 208, changes in water turbidity due to phytoplankton growth, and the like. Discriminative tasks such as image segmentation should be invariant to properties such as incident lighting, fish size, distance of fish 206 from the camera, fish species, and the like. General purpose supervised feature learning algorithms learn an encoding of input image data into a discriminative feature space. However, as mentioned before, in natural scene data, it is often difficult to model inter-class variations (e.g., differentiation between species of fish 206) while being invariant to intra-class variability due to the naturally occurring extrinsic factors such as illumination, pose, and the like.

Accordingly, in various embodiments, the image training data utilizes prior data (referred to herein as metadata) to aid in object classification and image segmentation by correlating some of the observed intra-class variations for aiding discriminative object detection and classification. The metadata is orthogonal to the image data and helps address some of the variability issues mentioned above by utilizing extrinsic information, including metadata corresponding to intra-class variations, to produce more accurate classification results. Further, in some embodiments, the image training data may utilize image-level labels, such as for weakly supervised segmentation and determining correspondence between image-level labels and pixels of an image frame.

In various embodiments, metadata includes data corresponding to a pose of the first image sensor system 202a within the marine enclosure 208, such as with respect to its orientation, location, and depth within the water column. In some embodiments, metadata includes illumination condition information such as time of day and sun position information which may be used to provide illumination incidence angle information. Further, in some embodiments, the training data also includes metadata corresponding to human tagging of individual image frames that provide an indication as to whether an image frame meets a predetermined minimum quality threshold for one or more intended use cases. Such metadata allows trained models to capture one or more aspects of intra-class variations. It should be recognized that although specific examples of metadata are mentioned herein for illustrative purposes, various metadata may be utilized during model training for the systems described herein without departing from the scope of this disclosure.

In some embodiments, machine learning classifiers are used to categorize observations in the training image data. For example, in various embodiments, such classifiers generate outputs including one or more labels corresponding to detected objects. In various embodiments, the classifiers determines class labels for underwater objects in image data including, for example, a species of fish, a swimming pattern of a school of fish, a size of each fish, a location of each fish, estimated illumination levels, a type of activity that objects are engaged in, and the like. Classifiers may also determine an angle of a fish's body relative to a camera and/or identify specific body parts (e.g., deformable objects such as fish bodies are associated with a constellation of body parts), and at least a portion of each object may be partially occluded in the field of view of the camera.

In some embodiments, a classifier includes utilizing a Faster recurrent convolutional neural network (R-CNN) to generate a class label output and bounding box coordinates for each detected underwater object in an image. In other embodiments, a classifier includes utilizing a Mask R-CNN as an extension of the Faster R-CNN object detection architecture that additionally outputs an object mask (e.g., an output segmentation map) for detected underwater objects in an image and classifies each and every pixel within an image. In some embodiments, classifiers are utilized when image training data does not include any labeling or metadata to provide ground truth annotations. In other embodiments, classifiers are utilized to provide additional context or dimensionality to labeled data.

Additionally, in some embodiments, contextual data includes an identification of individual fish 206 in captured imagery. For example, fish 206 may be identified after having been tagged using, for example, morphological marks, micro tags, passive integrated transponder tags, wire tags, radio tags, RFID tags, and the like. In various embodiments, image analysis may be performed on captured image data to identify a unique freckle ID (e.g., spot patterns) of a fish 206. This freckle ID may correspond to a unique signature of the fish 206 and may be used to identify the fish 206 in various images over time.

Dynamic conditions, such as a change in the environment 204 around the first image sensor system 202a and/or the second sensor system 202b, impact the operations and accuracy of sensor systems. In various embodiments, machine learning techniques may be used to determine various relationships between training images and the contextual image data to learn or identify relationships (e.g., as embodied in the trained models 214) between image data and sensor operating parameters associated with capturing desirable sensor measurements (e.g., an image frame meeting a predetermined minimum quality threshold for one or more intended use cases, an image frame capturing relevant info from an underwater scene, and the like). For example, such learned relationships may include a learned function between underwater object parameters (e.g., physical location of fish 206 within the marine enclosure 208 such as represented within image data set 212a), environmental parameters (e.g., the turbidity of a liquid medium such as represented within environmental data set 212b), one or more image labels/annotations, image metadata, and other contextual image data to one or more sensor operating parameters.

In various embodiments, the trained models 214 include an output function representing learned image sensor operating parameters. It should be recognized that the trained models 214 of system 200 may have multiple sensor operating parameters. It should be further recognized that the trained models 214, in various embodiments, include two or more trained models tailored to particular use cases, as sensor measurements captured in a vacuum independent of their intended uses may not contain sufficient data or data of a quality level necessary for a particular intended use. For example, an image frame having sufficient quality for a first use case may be wholly unsuitable for a second use case.

Accordingly, in some embodiments, the trained models 214 include a first trained model 214a for a first use case and at least a second trained model 214b for a second use case. As used herein, a “use case” refers to any specific purpose of use or particular objective intended to be achieved. For context purposes, in some embodiments, the first trained model 214a for the first use case may include a model trained to receive image data for identification and tracking of individual fish (rather than an aggregate population). In some embodiments, the second trained model 214b for the second use case may include a model trained to receive image data for monitoring aggregate population dynamics, such as for disease behavior monitoring or overall welfare monitoring within the marine enclosure 208. As will be appreciated, more granular detail is desirable in image data for the second use case. In other words, the various trained models 214 are trained towards different target variables depending on the particular needs of their respective use cases.

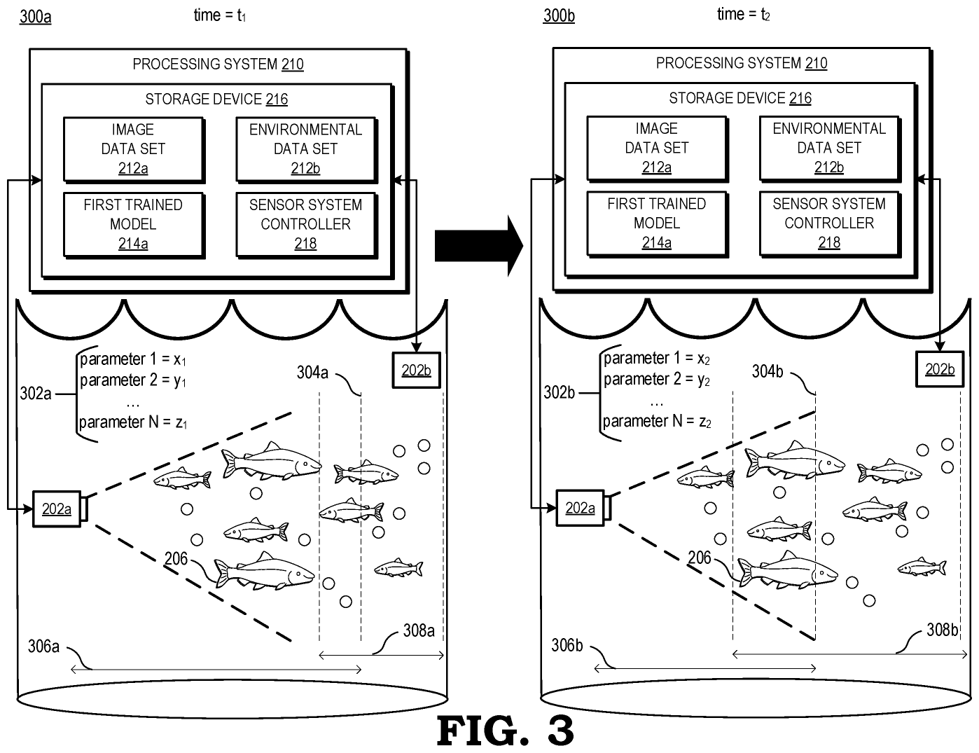

By way of non-limiting example, in various embodiments, use cases for the embodiments described herein may include, but are not limited to, identification of individual fish 206 from amongst a population, lice counting on each individual fish 206, detection and counting of feed pellets dispersed within the marine enclosure 208, aggregate population behavior analyses, feeding optimization, disease behavior monitoring, overall welfare monitoring, and the like. As will be appreciated, the characteristics of what represents a desirable image scene capture is dependent upon the specific use case. For example, a use case directed towards identification of individual fish 206 (such as described below in more detail with respect to FIG. 3) benefits from image data in which captured imagery of individual fish 206 are positioned within a depth of field in which objects are in focus (more so than a different use case, such as observation of aggregate population dynamics for which blurriness may be an acceptable tradeoff in exchange for image capture of a larger number of individuals within an image frame).

In various embodiments, the first trained model 214a may be trained to learn or identify a combination of intrinsic operating parameters for the first image sensor system 202a that enables capture of images having at least a minimum threshold quality level for the first use case. Similarly, the second trained model 214b may be trained to learn or identify a combination of intrinsic operating parameters for the first acoustic sensor system 202a that enables capture of images having at least a minimum threshold quality level for the second use case. As used herein, “extrinsic parameters” or “extrinsic operating parameters” generally refer to parameters that define the position and/or orientation of a sensor reference frame with respect to a known world reference frame (e.g., a world coordinate system). That is, extrinsic parameters represent the location of a sensor in a three-dimensional (3D) scene. In various embodiments, 3D world points may be transformed to 3D sensor coordinates using the extrinsic parameters.

In various embodiments, the 3D sensor coordinates may be mapped into a two-dimensional (2D) plane using intrinsic parameters. As used herein, in various embodiments, “intrinsic parameters” or “intrinsic operating parameters” refers to parameters that define operations of an sensor for data capture that are independent of its position and/or orientation within a 3D scene (i.e., does not include rotational or translational movement of the sensor in 3D space). For example, in some embodiments, an intrinsic operating parameter of an imaging sensor includes a parameter that links pixel coordinates of an image point with its corresponding coordinates in the camera reference frame, such as the optical center (e.g., principal point) and focal length of the camera. Similarly, in various embodiments, intrinsic operating parameters of an imaging sensor include any of a plurality of operating parameters that may be dynamically changed during operation of the image sensor so that an image may be captured using exposure settings, focus settings, and various other operating parameters that are most appropriate for capturing an image under prevailing scene conditions and for a particular use case.

In various embodiments, an intrinsic operating parameter includes a camera ISO representing camera sensor exposure for brightening or darkening a captured image. ISO includes gains to in image brightness after capture (e.g., light sensor sensitivity to light that is represented as a number). With respect to ISO, the lower the ISO, the darker an image will be; the higher the ISO, the brighter an image will be. For example, an image captured at a value of ISO 200 has brightness boosted by a factor of two relative to an image captured at a value of ISO 100. ISO increases occur at a cost to details, sharpness, and/or dynamic range, and may further introduce noise into an image. In general, lower ISO values will generally capture better quality imagery if the imaged scene is properly illuminated. However, a higher ISO value may achieve better image data capture such as when imaging in low light conditions.

In various embodiments, an intrinsic operating parameter includes a shutter speed controlling a length of time that a camera shutter is open to expose light into the camera sensor. Shutter speeds are typically measured in fractions of a second, with example shutter speeds including 1/15 (e.g., 1/15th of a second), 1/30, 1/60, 1/1000, 1/8000, and the like. Generally, more light is allowed to pass through to the camera sensor the longer that a shutter is open. Conversely, the shorter the amount of time that the shutter is open, the less light is able to pass through to the camera sensor. Accordingly, shutter speed impacts how long a camera's sensor is exposed to light and further is responsible for the appearance of motion in an image frame.

Factors such as speed of object movement in scenes, movements in the pose of the camera within the underwater environment (e.g., swaying in the water current) and the like will influence whether imaged underwater objects will appear as frozen in place or blurred within a captured image. As an example, in some embodiments, the camera may be deployed in an underwater environment subject to strong water current flow such that the first image sensor system 202a and the marine enclosure 208 to which it is coupled sways and bobs in the water. In such circumstances, one or more of the trained models 214 may determine, based at least in part on environmental data including current flow information, that a shutter speed operating parameter of the first image sensor system 202a should be adjusted to a faster shutter speed to compensate for water-current-induced movements and decreasing an amount of blur that would otherwise be evident within captured imagery.

In various embodiments, an intrinsic operating parameter includes an aperture size that controls the opening of a lens's diaphragm (i.e., the aperture) through which light passes through. Instead of controlling an amount of light that is exposed to the camera sensor as a function of time (as does shutter speeds), apertures control the amount of light entering a lens as a function of the physical size of the aperture opening. Generally, larger apertures provide more exposure and smaller apertures provide less light exposure to the camera sensor. Apertures are often represented in terms of f-numbers (also referred to as the “f-stop” or “focal ratio”, since the f-number is the ratio of a focal length of the imaging system to a diameter of the lens aperture) and is a quantitative measure of lens speed. Examples of f-numbers include dimensionless numbers such as f/1.4, f/2.0, f/2.8, f/4.0, f/5.6, f/8.0, and the like. Decreasing aperture size (i.e., increasing f-numbers) provides less exposure as the light-gathering area of the aperture decreases.

In various embodiments, aperture is related to shutter speed in that using a low f-number (e.g., a larger aperture size) results in more light is entering the lens and therefore the shutter does not need to stay open as long for a desired exposure level, which translates into a faster shutter speed. Conversely, using a high f-number (e.g., a smaller aperture size) results in less light is entering the lens and therefore the shutter does not need to stay open as long for a desired exposure, which translates into a slower shutter speed. Additionally, as discussed in more detail below, aperture size is also a factor in controlling the depth of field.

Each of the shutter speed parameter (e.g., controls duration of exposure), the ISO value parameter (e.g., controls applied gain to represent sensitivity of camera sensor to a given amount of light), and the aperture size parameter (e.g., controls the area over which light can enter the camera) will affect an overall exposure setting differently. As will be appreciated, various combinations of one or more of the above three parameters related to an exposure setting may achieve the same exposure. The key, however, is understanding which trade-offs to make, since each exposure setting also influences other image properties. For example, aperture affects depth of field, shutter speed affects motion blur, and ISO values affect image noise.

In some embodiments, an intrinsic operating parameter includes a focal length (usually stated in millimeter terms) of the camera lens representing optical distance from the camera lens to a point where all light rays are in focus inside the camera. Generally, the shorter the focal length, the greater the extent of the scene captured by the camera lens. Conversely, the longer the focal length, the smaller the extent of the scene captured by the camera lens. If the same subject is photographed from the same distance, its apparent size will decrease as the focal length gets shorter and the field of view widens. As the focal length increases (e.g., by moving the camera lens further from the image sensor), an optical zoom parameter of the camera increases because a smaller portion of the scene strikes the image sensor due to a narrower field of view and resulting in magnification.

In various embodiments, an intrinsic operating parameter includes a focal plane representing the distance between the camera lens and a perfect point of focus in an imaged scene (referred to herein as the “focal distance”). That is, the focal plane is the distance in front the camera lens at which the sharpest focus is attained and spans horizontally, left to right, across the image frame. When focused on an individual point within the scene (e.g., sometimes referred to as the focal point), the focal plane lies parallel to the camera sensor. Everything in front of, and behind, that focal plane is technically not in focus; however, there is a region within which objects will appear acceptably sharp that is, the depth of field. Depth of field is a phenomenon of near and far, forward and backward from the focal point, and is the zone of acceptable sharpness (referred to as the circle of confusion) in front of and behind the subject on which the lens is focused.

It should be recognized that as the depth of field increases, it does not do so equilaterally from the focal point. For example, given a hypothetical in which the focal distance is 10 feet away from the camera lens and the total depth of field is 2 feet, the focal range would not be between 9-11 feet away. Instead, the majority of the total depth of field exists beyond the focal point because the increase in depth of field is associated with exponential growth with larger apertures and further focusing distances. In various embodiments, the depth of field may be adjusted based on parameters including, for example, aperture, focal distance, focal length, and distance to the imaged subject. Generally, smaller apertures (e.g., f/8-f/22), shorter focal lengths (e.g., 10-35 mm), and/or longer focal distances produce a larger depth of field. Conversely, wider apertures (e.g., f/1.4-f/5.6), longer focal lengths (e.g., 70-600 mm), and/or shorter focal distances produce a smaller depth of field.

It should be recognized although various specific examples of intrinsic operating parameters are discussed herein for illustrative purposes, various intrinsic operating parameters may be dynamically reconfigured during sensor system operations without departing from the scope of this disclosure. For example, in various embodiments, intrinsic operating parameters may further include, but are not limited to, a pixel skew coefficient, a frame rate of camera image capture, radial lens distortion, tangential lens distortion, a horizontal lens shift position for framing a shot of image capture from a different perspective, a vertical lens shift position for framing a shot of image capture from a different perspective, an angular lens shift position, and the like. It should be appreciated that such lens shifting allows for reframing of image shots via changing of image sensor intrinsic operating parameters to achieve results similar to tilting and panning of cameras without having to change a pose of the camera.

As discussed above, in various embodiments, the trained models 214 include an output function representing learned image sensor operating parameters. Such trained models 214 may be utilized by, for example, a sensor controller 218 to dynamically reconfigure the intrinsic operating parameters of the first image sensor system 202a for capturing image data with minimal operator input during operations. For example, in various embodiments, the first trained model 214a may be trained to learn or identify a combination of intrinsic operating parameters for the first image sensor system 202a that enables capture of images having at least a minimum threshold quality level for the first use case.

It should be appreciated that one or more of the various intrinsic operating parameters influence image composition; further, changing such intrinsic operating parameters relative to each other may have complementary or antagonistic effects on image quality dependent upon various factors including but not limited to the prevailing underwater conditions (e.g., fish behavior/positioning as represented by underwater object parameters within image data set 212a and/or environmental factors as represented by environmental parameters within environmental data set 212b), the particular use case for captured image data is intended, and the like. Accordingly, after receiving input data indicative of underwater conditions within or proximate to the marine enclosure 208 (e.g., including image data set 212a and/or environmental data set 212b), the first trained model 214a outputs a set of intrinsic operating parameters that is determined to provide, on balance, image data of sufficient quality for its intended purposes for the first use case and under current prevailing conditions. In this manner, the dynamic sensor operating parameter reconfiguration of system 200 improves image data capture with more reliable and accurate image capture techniques that allow for obtaining of improved data upon which farmers can better optimize precision aquaculture operations according to variations in the marine enclosure 208, which ultimately leads to increased yields and product quality.

In various embodiments, the sensor controller 218 instructs the first image sensor system 202a to obtain a set of one or more images in response to re-configuring the image sensor system according to the determined sensor intrinsic operating parameters. The set of one or more images include images of the one or more underwater objects in the marine enclosure 208. As will be appreciated, marine enclosures 208 are generally positioned in environments 204 within which the farmer operator has limited to no ability to manually influence extrinsic variations during data gathering. For example, the underwater farming environment 204 is generally not a controlled environment in which environmental conditions or underwater object behavior may be manually adjusted easily to create improved conditions for image capture. Similarly, artificial illumination sources (e.g., lights) if present within the marine enclosure 208 may sometimes be controlled but is subject to availability and distance from desired subjects to be imaged, and are therefore unreliable in their applicability and efficacy in improving conditions for image data capture.

Accordingly, in various embodiments, while extrinsic camera parameters may be taken into account during analysis, the system 200 dynamically reconfigures intrinsic operating parameters without modifying extrinsic operating parameters. This is particularly beneficial for stationary sensor systems 202 without repositioning capabilities and/or for reducing disadvantages associated with physically repositioning sensors (e.g., more moving parts that increase possibilities of equipment malfunctions, disturbing the fish 106 which may negatively impact welfare and increase stress, disrupting normal farm operations, and the like).

For context purposes, with respect to FIG. 3 and with continued reference to FIG. 2, illustrated is an example of dynamic intrinsic operating parameter reconfiguration of an image sensor system within underwater environment 204. As illustrated in the two panel views 300a and 300b, a first image sensor system 202a is positioned below the water surface and configured to capture still images and/or record moving images (e.g., video data). Although the first image sensor system 202a is shown in FIG. 3 to be positioned below the water surface, those skilled in the art will recognize that one or more cameras of the first image sensor system 202a may be deployed under the water surface, at the water surface, above the water surface, remote to the locale at which the fish 206 are located, remote to the processing system 210, or any combination of the above without departing from the scope of this disclosure.

The one or more cameras are directed towards the surrounding environment 204, with each camera capturing a sequence of images (e.g., video frames) of the environment 204 and any objects in the environment. In various embodiments, the one or more cameras monitor an individual fish, multiple fish, or an entire population of fish within the marine enclosure 208. Such image data measurements may, for example, be used to identify fish positions within the water.

As illustrated in panel view 300a, the fish 206 are positioned within the marine enclosure 208 at a first time period t₁. In panel view 300a, the first image sensor system 202a is configured to operate according to a first set of intrinsic operating parameters 302a such that a first focal plane 304a is located at a first focal distance 306a away from the image sensor system 202a. Further, the first focal distance 306a in combination with one or more parameters of the first set of intrinsic operating parameters 302a (e.g., aperture size and the like) results in a first depth of field 308a.

In panel view 300a, the first depth of field 308a is deficient in that a majority of the fish 206 are positioned outside the first depth of field 308a (e.g., outside of the range of acceptable sharpness) and therefore would appear out of focus within captured imagery. In various embodiments, the processing system 210 receives one or more data sets 212 (e.g., image data set 212a and environmental data set 212b) and stores the data sets 212 at the storage device 216 for processing. In various embodiments, the data sets 212 include data indicative of one or more conditions at one or more locations at which their respective sensor systems 202 are positioned. For example, in some embodiments, the image data set 212a includes image data representing any image-related value or other measurable factor/characteristic that is representative of at least a portion of a data set describing the presence (or absence), abundance, distribution, size, and/or behavior of underwater objects (e.g., a population of fish 206 as illustrated in panel view 300a of FIG. 3). In various embodiments, the data sets 212 also include environmental data set 212b includes environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosure 208.

In the context of FIG. 3, dynamic conditions, such as a change in the environment 204 around the first image sensor system 202a (e.g., due to movement of the fish 206 within the marine enclosure 208) and/or the second sensor system 202b, impact the operations and accuracy of sensor systems. In particular, as illustrated in panel view 300a, first depth of field 308a is deficient in that a majority of the fish 206 are positioned outside the first depth of field 308a (e.g., outside of the range of acceptable sharpness) and therefore would appear out of focus within captured imagery of the image data set 212a.

As discussed above, the data sets 212 including the image data set 212a and/or the environmental data set 212b are provided as input to one or more trained models 214 (e.g., a first trained model 214a for a first use case and at least a second trained model 214b for a second use case). In various embodiments, the first trained model 214a is trained to learn or identify a combination of intrinsic operating parameters for the first image sensor system 202a that enables capture of images having at least a minimum threshold quality level for the first use case. For context purposes, in some embodiments, the first trained model 214a for the first use case may include a model trained to receive image data for identification and tracking of individual fish (rather than an aggregate population).

In various embodiments, the trained models 214 include an output function representing learned image sensor operating parameters. Such trained models 214 may be utilized by, for example, the sensor controller 218 to dynamically reconfigure the intrinsic operating parameters of the first image sensor system 202a for capturing image data with minimal operator input during operations. For example, in various embodiments, the first trained model 214a may be trained to learn or identify a combination of intrinsic operating parameters for the first image sensor system 202a that enables capture of images having at least a minimum threshold quality level for the first use case.

Accordingly, after receiving input data indicative of underwater conditions within or proximate to the marine enclosure 208 (e.g., including image data set 212a and/or environmental data set 212b), the first trained model 214a determines and outputs a set of intrinsic operating parameters (as represented by the second set of intrinsic operating parameters 302b in FIG. 3) that is determined to provide improvement of image data quality under prevailing conditions (e.g., fish position within the marine enclosure 208) and further for the first use case (e.g., monitoring aggregate population dynamics).

In one embodiment, as illustrated in panel view 300b, the sensor controller 218 configures the first image sensor system 202a according to the determined second set of intrinsic operating parameters 302b such that one or more intrinsic operating parameters are changed relative to the first set of intrinsic operating parameters 302a for a second time period t₂. In general, the second time period t₂ includes any time interval subsequent to that of the first time period t₁ and may be of any time duration. Thus, in some embodiments, the image sensor reconfiguration described herein with respect to FIGS. 2 and 3 may be performed on a periodic basis in accordance with a predetermined schedule. In other embodiments, the prevailing conditions of the environment 204 may be continuously monitored such that the first image sensor system 202 is dynamically reconfigured in close to real-time as appropriate for particular use cases and in response to data represented within data sets 212.

As illustrated in panel view 300b, the fish 206 are positioned within the marine enclosure 208 at approximately the same positions as they were in panel view 300a for the first time period t₁. However, in panel view 300b, the image sensor system 202a has been reconfigured according to the determined second set of intrinsic operating parameters 302b such that a second focal plane 304a is located at a second focal distance 306b away from the image sensor system 202a. The second focal distance 306b in combination with one or more parameters of the second set of intrinsic operating parameters 302b (e.g., aperture size and the like) results in a second depth of field 308b.

In various embodiments, the sensor controller 218 instructs the image sensor system 202a to obtain a set of one or more images in response to re-configuring the image sensor system according to the determined sensor intrinsic operating parameters. Thus, the second depth of field 308b associated with the second set of intrinsic operating parameters 302b results in capture of different imagery for the same pose and substantially the same scene, shot at the first time period t₁ for panel view 300a (left) and the second time period t₂ for panel view 300b (right). In particular, a greater number of fish 206 are positioned in the second depth of field 308b relative to the first depth of field 308a, and therefore will appear to be in focus within captured imagery.

Accordingly, in various embodiments, the processing system 210 dynamically reconfigures intrinsic operating parameters without modifying extrinsic operating parameters (although extrinsic camera parameters may be taken into account during analysis and processing of data sets 212 by the trained models). In other embodiments, the processing system 210 changes a pose of the image sensor system 202a without physically repositioning (e.g., translational movement within the environment 204) the sensor system away from its three-dimensional position within the marine enclosure 208. For example, in some embodiments, the processing system 210 may reconfigure the pose (not shown) by changing the external orientation (e.g., rotational movement of the image sensor housing about one or more axes) of the image sensor system 202a relative to the environment 204. The dynamic reconfiguration of intrinsic operating parameters is particularly beneficial for stationary sensor systems 202 without repositioning capabilities and/or for reducing disadvantages associated with physically repositioning sensors. In this manner, the quality of captured image data is improved in underwater farming environments 204 that are generally not controlled environments in which environmental conditions or underwater object behavior may be manually adjusted easily to create improved conditions for image capture.

It should be recognized that FIG. 3 is described primarily in the context of dynamic reconfiguration of image sensor intrinsic parameters based on the underwater object parameter of fish position within the water column for ease of illustration and description. However, those skilled in the art will recognize that the image sensors for FIGS. 2 and 3 may be dynamically reconfigured based on data indicative of any number of underwater object parameters and/or environmental parameters. It should further be recognized that although FIG. 3 is described in the specific context of an image sensor, the one or more sensor systems of FIG. 3 may include any number of and any combination of various image and/or environmental sensors without departing from the scope of this disclosure.

Additionally, although dynamic sensor operating parameter reconfiguration is described with respect to FIGS. 2 and 3 primarily in the context of below-water image sensors and below-water environmental sensors, data may be collected by any of a variety of imaging and non-imaging sensors. By way of non-limiting examples, in various embodiments, the sensor systems may include various sensors local to the site at which the fish are located (e.g., underwater telemetry devices and sensors), sensors remote to the fish site (e.g., satellite-based weather sensors such as scanning radiometers), various environmental monitoring sensors, active sensors (e.g., active sonar), passive sensors (e.g., passive acoustic microphone arrays), echo sounders, photo-sensors, ambient light detectors, accelerometers for measuring wave properties, salinity sensors, thermal sensors, infrared sensors, chemical detectors, temperature gauges, or any other sensor configured to measure data. It should be further recognized that, in various embodiments, the sensor systems utilized herein are not limited to below-water sensors and may include combinations of a plurality of sensors at different locations. It should also be recognized that, in various embodiments, the sensor systems utilized herein are not limited to single sensor-type configurations. For example, in various embodiments, the sensor systems may include two different sensor systems positioned at different locations (e.g., under water and above water) and/or a plurality of differing environmental sensors.

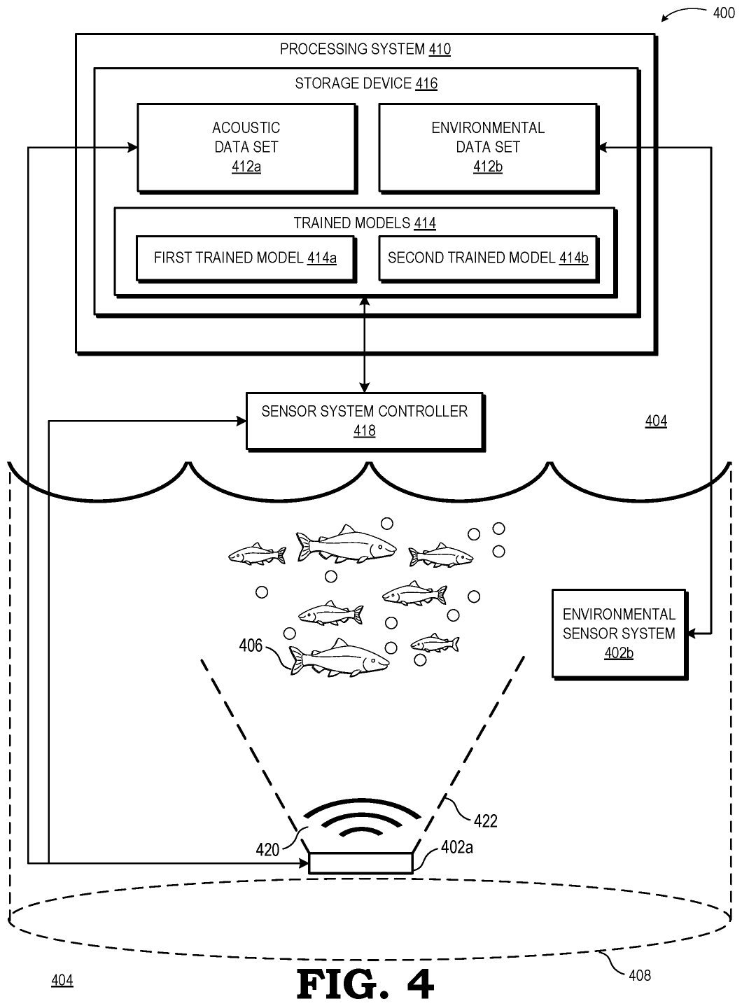

Referring now to FIG. 4, illustrated is a diagram showing a system 400 implementing dynamic reconfiguration of acoustic sensor systems in accordance with some embodiments. In various embodiments, the system 400 includes one or more sensor systems 402 that are each configured to monitor and generate data associated with the environment 404 within which they are placed. In general, the one or more sensor systems 402 measure and convert physical parameters such as, for example, moisture, heat, motion, light levels, and the like to analog electrical signals and/or digital data.

As shown, the one or more sensor systems 402 includes a first acoustic sensor system 402a including one or more hydroacoustic sensors configured to observe fish behavior and capture acoustic measurements. The one or more sensor systems 402 are configured to monitor the environment 404. For example, in various embodiments, the hydroacoustic sensors are configured to capture acoustic data corresponding to the presence (or absence), abundance, distribution, size, and behavior of underwater objects (e.g., a population of fish 406 as illustrated in FIG. 4). Further, in various embodiments, the system 400 may be used to monitor an individual fish, multiple fish, or an entire population of fish within the marine enclosure 408. Such acoustic data measurements may, for example, be used to identify fish positions within the water.

As used herein, it should be appreciated that an “object” refers to any stationary, semi-stationary, or moving object, item, area, or environment in which it may be desired for the various sensor systems described herein to acquire or otherwise capture data of. For example, an object may include, but is not limited to, one or more fish, crustacean, feed pellets, predatory animals, and the like. However, it should be appreciated that the sensor measurement acquisition and analysis systems disclosed herein may acquire and/or analyze sensor data regarding any desired or suitable “object” in accordance with operations of the systems as disclosed herein.

The one or more sensor systems 402 may include one or more of a passive acoustic sensor and/or an active acoustic sensor (e.g., an echo sounder and the like). In various embodiments, the one or more sensor systems 402 includes a first acoustic sensor system 402a that utilizes active sonar systems in which pulses of sound are generated using a sonar projector including a signal generator, electro-acoustic transducer or array, and the like. Although FIG. 4 only shows a single hydroacoustic sensor for ease of illustration and description, persons of ordinary skill in the art having benefit of the present disclosure should appreciate that the first acoustic sensor system 402a can include any number of and/or any arrangement of hydroacoustic sensors within the environment 404 (e.g., sensors positioned at different physical locations within the environment, multi-sensor configurations, and the like).

In some embodiments, the first acoustic sensor system 402a utilizes active sonar systems in which pulses of sound are generated using a sonar projector including a signal generator, electro-acoustic transducer or array, and the like. Active acoustic sensors conventionally include both an acoustic receiver and an acoustic transmitter that transmit pulses of sound (e.g., pings) into the surrounding environment 404 and then listens for reflections (e.g., echoes) of the sound pulses. It is noted that as sound waves/pulses travel through water, it will encounter objects having differing densities or acoustic properties than the surrounding medium (i.e., the underwater environment 404) that reflect sound back towards the active sound source(s) utilized in active acoustic systems. For example, sound travels differently through fish 406 (and other objects in the water such as feed pellets 426) than through water (e.g., a fish's air-filled swim bladder has a different density than water). Accordingly, differences in reflected sound waves from active acoustic techniques due to differing object densities may be accounted for in the detection of aquatic life and estimation of their individual sizes or total biomass. It should be recognized that although specific sensors are described below for illustrative purposes, various hydroacoustic sensors may be implemented in the systems described herein without departing from the scope of this disclosure.

The active sonar system may further include a beamformer (not shown) to concentrate the sound pulses into an acoustic beam 420 covering a certain search angle 422. In some embodiments, the first acoustic sensor system 402a measures distance through water between two sonar transducers or a combination of a hydrophone (e.g., underwater acoustic microphone) and projector (e.g., underwater acoustic speaker). The first acoustic sensor system 402a includes sonar transducers (not shown) for transmitting and receiving acoustic signals (e.g., pings). To measure distance, one transducer (or projector) transmits an interrogation signal and measures the time between this transmission and the receipt of a reply signal from the other transducer (or hydrophone). The time difference, scaled by the speed of sound through water and divided by two, is the distance between the two platforms. This technique, when used with multiple transducers, hydrophones, and/or projectors calculates the relative positions of objects in the underwater environment 404.

In other embodiments, the first acoustic sensor system 402a includes an acoustic transducer configured to emit sound pulses into the surrounding water medium. Upon encountering objects that are of differing densities than the surrounding water medium (e.g., the fish 206), those objects reflect back a portion of the sound towards the sound source (i.e., the acoustic transducer). Due to acoustic beam patterns, identical targets at different azimuth angles will return different echo levels. Accordingly, if the beam pattern and angle to a target is known, this directivity may be compensated for. In various embodiments, split-beam echosounders divide transducer faces into multiple quadrants and allow for location of targets in three dimensions. Similarly, multi-beam sonar projects a fan-shaped set of sound beams outward from the first acoustic sensor system 402a and record echoes in each beam, thereby adding extra dimensions relative to the narrower water column profile given by an echosounder. Multiple pings may thus be combined to give a three-dimensional representation of object distribution within the water environment 404.

In some embodiments, the one or more hydroacoustic sensors of the first acoustic sensor system 402a includes a Doppler system using a combination of cameras and utilizing the Doppler effect to monitor the appetite of salmon in sea pens. The Doppler system is located underwater and incorporates a camera, which is positioned facing upwards towards the water surface. In various embodiments, there is a further camera for monitoring the surface of the pen. The sensor itself uses the Doppler effect to differentiate pellets 426 from fish 406.

In other embodiments, the one or more hydroacoustic sensors of the first acoustic sensor system 402a includes an acoustic camera having a microphone array (or similar transducer array) from which acoustic signals are simultaneously collected (or collected with known relative time delays to be able to use phase different between signals at the different microphones or transducers) and processed to form a representation of the location of the sound sources. In various embodiments, the acoustic camera also optionally includes an optical camera.

Additionally, as illustrated in FIG. 4, the one or more sensor systems 202 includes a second sensor system 402b positioned below the water surface and including a second set of one or more sensors. In various embodiments, the second set of one or more sensors include one or more environmental sensors configured to monitor the environment 404 below the water surface and generate data indicative of one or more environmental conditions associated with the marine enclosure 408. Although the second sensor system 402b is shown in FIG. 4 to be positioned below the water surface, those skilled in the art will recognize that one or more of the environmental sensors of the second sensor system 402b may be deployed under the water surface, at the water surface, above the water surface, remote to the locale at which the fish 406 are located, remote to the processing system 410, or any combination of the above without departing from the scope of this disclosure.

In various embodiments, the second sensor system 402b of FIG. 4 includes one or more environmental sensors configured to capture measurements associated with the environment 404 within which the system 400 is deployed. As described in further detail below, in various embodiments, the environmental sensors of the second sensor system 402b generate environmental data that serves as reference data for implementing the dynamic reconfiguration of sensor system operating parameters. Such environmental data may include any measurement representative of the environment 404 within which the environmental sensors are deployed.

For example, in various embodiments, the environmental data (and any data sets corresponding to the environmental data) may include, but is not limited to, any of a plurality of water turbidity measurements, water temperature measurements, metocean measurements, weather forecasts, air temperature, dissolved oxygen, current direction, current speeds, and the like. Further, the environmental parameters and environmental data may include any combination of present, past, and future (e.g., forecasts) measurements of meteorological parameters (e.g., temperature, wind speed, wind direction), water environment parameters (e.g., water temperature, current speed, current direction, dissolved oxygen levels, turbidity levels), air environment parameters, other environmental parameters, and the like. It should be recognized that although specific environmental sensors are described here for illustrative purposes, the second sensor system 402b may include any number of and any combination of various environmental sensors without departing from the scope of this disclosure.

In various embodiments, the processing system 410 receives one or more data sets 412 (e.g., acoustic data set 412a and environmental data set 412b) and stores the data sets 412 at the storage device 416 for processing. In various embodiments, the data sets 412 include data indicative of one or more conditions at one or more locations at which their respective sensor systems 402 are positioned. For example, in some embodiments, the acoustic data set 412a includes acoustic data representing any acoustic-related value or other measurable factor/characteristic that is representative of at least a portion of a data set that describes the presence (or absence), abundance, distribution, size, and/or behavior of underwater objects (e.g., a population of fish 406 as illustrated in FIG. 4). With respect to acoustic data, the acoustic data set 412a may also include acoustic measurements capturing measurements representative of the relative and/or absolute locations of individual and/or aggregates of the population of fish 406 within the environment 404. Such acoustic data may be indicative of one or more underwater object parameters corresponding to one or more underwater objects (e.g., fish 406) within the marine enclosure 408. The acoustic data may be indicative of, for example, movement of one or more objects, orientation of one or more objects, swimming pattern or swimming behavior of one or more objects, jumping pattern or jumping behavior of one or more objects, any activity or behavior of one or more objects, and the like.

It should be recognized that although the underwater object parameter has been abstracted and described here generally as “acoustic data” for ease of description, those skilled in the art will understand that acoustic data (and therefore the acoustic data set 412a corresponding to the acoustic data) may also include, but is not limited to, any of a plurality of acoustics measurements, acoustic sensor specifications, operational parameters of acoustic sensors, and the like.

In some embodiments, the environmental data set 412b includes environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosure 408. For example, in some embodiments, the environmental sensors of the second sensor system 402b includes an ambient light sensor or other photodetector configured to sense or otherwise measure an amount of ambient light present within the environment local to the sensor. In various embodiments, the environmental sensors of the second sensor system 402b includes a turbidity sensor configured to measure an amount of light scattered by suspended solids in the water.

As will be appreciated, variable parameters corresponding to variance in underwater conditions in the environment 404 include, for example, variance in underwater object parameters (e.g., physical location of fish 406 within the marine enclosure 408 such as represented within acoustic data set 412a) and variance in environmental parameters (e.g., the turbidity of a liquid medium such as represented within environmental data set 412b). Underwater conditions often vary and the accuracy of data gathered by different sensor systems will also vary over time. For example, the positions and distribution of fish 406 within the marine enclosure 408 will vary over time due to, for example, swimming pattern changes resulting from environmental factors such as temperature, lighting, and water currents, and timings of fish activities related to schooling, feeding, resting, and the like.

Accurate fish 406 (and other objects) detection and quantification is a crucial component for perception-related tasks in aquaculture. However, the variability of underwater objects and/or the environment will affect the accuracy of acoustics-based measurements and accordingly the accuracy or reliability of any subsequent processes related to the acoustics-based measurements (including human-based observations and assessments, machine-based processes which may consume the acoustic data/acoustics-based measurements as input, and the like). Accordingly, in various embodiments, acoustic data (which in various embodiments includes at least a subset of acoustic data captured by one or more hydroacoustic sensors of the first acoustic sensor system 402a) and environmental data (which in various embodiments includes at least a subset of environmental data captured by one or more environmental sensors of the second sensor system 402b) is provided as training data to generate trained models 414 using machine learning techniques and neural networks.

In various embodiments, the training data includes various hydroacoustic measurements corresponding to sound waves generated by the acoustic sensor system 402a which propagates through the water column and interact with underwater objects (e.g., fish 406, feed pellets 426, and the like). In various embodiments, the interaction of the sound waves with underwater objects generate incoherent scattered and coherent reflected fields that are sampled in space and time by a receiver array of the acoustic sensor system 402a. Acoustic scattering and reflection depend on the physical properties of the underwater objects.

Array signal processing is applied to the recorded acoustic signals (e.g., echoes) to locate or identify objects of interest. The received signals in an echo time series depend on physical properties of the underwater objects, such as object density, volume scattering strength, reflection coefficient, sound attention, and the like). The received signals will also depend on other factors such as acoustic source strength, receiver sensitivity, pulse length, frequency, beam width, propagation loss, and the like.

Accordingly, in various embodiments, hydroacoustic measurements corresponding to sound waves generated by the acoustic sensor system 402a are annotated or otherwise labeled to identify, for example, individual fish, populations of fish, different fish species, fish behavior, fish density within the water column, feed pellets in the water, and various other identifiable features within acoustics data to serve as ground truth observations. Further, in various embodiments, the training data also includes contextual acoustics data (e.g., provided as acoustic metadata) indicating, for example, one or more of ambient sound conditions, temperature conditions, acoustic transducer and receiver locations, topology of the determined area, current direction or strength, salinity levels, oxygen levels, fish activities, and timing data at the time an acoustic measurement was captured.

Underwater acoustics data, which is often captured in uncontrolled nature environments 404, is subject to large intra-class variation due to, for example, changing ambient noise conditions as current strength and water flow change, changing weather (e.g., storms), changing fish 406 positions as they swim throughout the marine enclosure 408, changes in fish 406 behavior due to feeding, and the like. General purpose supervised feature learning algorithms learn an encoding of input acoustics data into a discriminative feature space. In natural scene data, it is often difficult to remain invariant to intra-class variability due to the naturally occurring extrinsic factors such as weather conditions, environmental conditions, pose of sensors relative to fish, and the like.

Accordingly, in various embodiments, the acoustic training data utilizes prior data (referred to herein as metadata) to aid in object classification and object labeling by correlating some of the observed intra-class variations for aiding discriminative object detection and classification. The metadata is orthogonal to the acoustic data and helps address some of the variability issues mentioned above by utilizing extrinsic information, including metadata corresponding to intra-class variations, to produce more accurate classification results.

In various embodiments, metadata includes data corresponding to a pose of the first acoustic sensor system 402a within the marine enclosure 408, such as with respect to its orientation, location, and depth within the water column. In some embodiments, metadata includes weather condition information such as time of day to provide context for natural fish behavior that changes over the course of a day and weather information which may be used to provide ambient noise information. Further, in some embodiments, the training data also includes metadata corresponding to human tagging that provides an indication as to whether acoustics data for a given time period meets a predetermined minimum quality threshold for one or more intended use cases. Such metadata allows trained models to capture one or more aspects of intra-class variations. It should be recognized that although specific examples of metadata are mentioned herein for illustrative purposes, various metadata may be utilized during model training for the systems described herein without departing from the scope of this disclosure.

In some embodiments, machine learning classifiers are used to categorize observations in the training acoustic data. For example, in various embodiments, such classifiers generate outputs including one or more labels corresponding to detected objects. In various embodiments, the classifiers determines class labels for underwater objects in acoustic data including, for example, a species of fish, a swimming pattern of a school of fish, a total biomass of fish within the marine enclosure 408, a location of each fish, a biomass of each fish, a type of activity that objects are engaged in, a density and distribution of biomass within the water column, and the like.

In some embodiments, a classifier includes utilizing a Faster recurrent convolutional neural network (R-CNN) to generate a class label output for detected underwater objects in acoustic data. In other embodiments, a classifier includes utilizing a Mask R-CNN as an extension of the Faster R-CNN object detection architecture that additionally outputs an object mask (e.g., an output segmentation map) for detected underwater objects. In some embodiments, classifiers are utilized when acoustic training data does not include any labeling or metadata to provide ground truth annotations. In other embodiments, classifiers are utilized to provide additional context or dimensionality to labeled data.

Dynamic conditions, such as a change in the environment 404 around the first acoustic sensor system 402a and/or the second sensor system 402b, impact the operations and accuracy of sensor systems. In various embodiments, machine learning techniques may be used to determine various relationships between acoustic training data and the contextual acoustic data to learn or identify relationships (e.g., as embodied in the trained models 414) between acoustic data and sensor operating parameters associated with capturing desirable sensor measurements (e.g., acoustic measurements meeting a predetermined minimum quality threshold for one or more intended use cases, acoustic measurements capturing relevant info from an underwater scene, and the like). For example, such learned relationships may include a learned function between underwater object parameters (e.g., physical location of fish 406 within the marine enclosure 408 such as represented within acoustic data set 412a), environmental parameters (e.g., ambient noise levels such as represented within environmental data set 412b), one or more acoustic labels/annotations, acoustic metadata, and other contextual acoustic data to one or more sensor operating parameters.

In various embodiments, the trained models 414 include an output function representing learned acoustic sensor operating parameters. It should be recognized that the trained models 414 of system 400 may have multiple sensor operating parameters. It should be further recognized that the trained models 414, in various embodiments, include two or more trained models tailored to particular use cases, as sensor measurements captured in a vacuum independent of their intended uses may not contain sufficient data or data of a quality level necessary for a particular intended use. For example, acoustic measurements having sufficient quality for a first use case may be wholly unsuitable for a second use case.

Accordingly, in some embodiments, the trained models 414 include a first trained model 414a for a first use case and at least a second trained model 414b for a second use case. As used herein, a “use case” refers to any specific purpose of use or particular objective intended to be achieved. For context purposes, in some embodiments, the first trained model 414a for the first use case may include a model trained to receive acoustic data for estimating a number of individual fish and combined biomass within an area of the marine enclosure 408. In some embodiments, the second trained model 414b for the second use case may include a model trained to receive acoustic data for monitoring aggregate population dynamics, such as for determining whether population behavior is indicative of certain conditions (e.g., hunger, sickness, and the like). As will be appreciated, more granular detail is desirable in acoustic data for the first use case. In other words, the various trained models 214 are trained towards different target variables depending on the particular needs of their respective use cases.

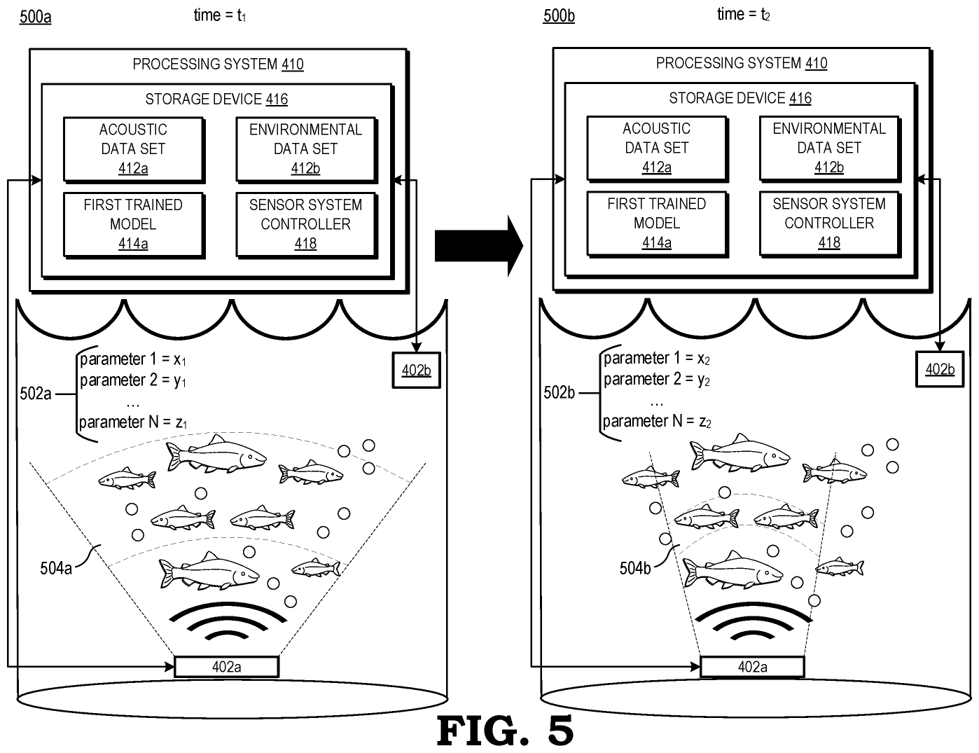

By way of non-limiting example, in various embodiments, use cases for the embodiments described herein may include, but are not limited to, identification of fish 406 schooling behavior, identification of fish 406 swimming close to the water surface, detection and counting of feed pellets dispersed within the marine enclosure 408, aggregate population behavior analyses, feeding optimization, disease behavior monitoring, overall welfare monitoring, and the like. As will be appreciated, the characteristics of what represents desirable acoustic data is dependent upon the specific use case. For example, a use case directed towards estimating a number of individual fish and combined biomass within an area of the marine enclosure 408 (such as described below in more detail with respect to FIG. 5) benefits from acoustic data in which captured acoustic data has sufficient resolution such as to be able to detect and distinguish between two different underwater objects (more so than a different use case, such as observation of aggregate population dynamics for which lower resolution may be an acceptable tradeoff in exchange for holistic measurement of a larger number of individuals within a single measurement, such as to get a snapshot of activity with the entire marine enclosure 408).

In various embodiments, the first trained model 414a may be trained to learn or identify a combination of intrinsic operating parameters for the first acoustic sensor system 402a that enables capture of acoustic data having at least a minimum threshold quality level for the first use case. Similarly, the second trained model 414b may be trained to learn or identify a combination of intrinsic operating parameters for the first acoustic sensor system 402a that enables capture of acoustic data having at least a minimum threshold quality level for the second use case. As used herein, “extrinsic parameters” or “extrinsic operating parameters” generally refer to parameters that define the position and/or orientation of a sensor reference frame with respect to a known world reference frame (e.g., a world coordinate system). That is, extrinsic parameters represent the location of a sensor in a three-dimensional (3D) scene. In various embodiments, 3D world points may be transformed to 3D sensor coordinates using the extrinsic parameters.

In various embodiments, the 3D sensor coordinates may be mapped into a two-dimensional (2D) plane using intrinsic parameters. As used herein, in various embodiments, “intrinsic parameters” or “intrinsic operating parameters” refers to parameters that define operations of an sensor for data capture that are independent of its position and/or orientation within a 3D scene (i.e., does not include rotational or translational movement of the sensor in 3D space). For example, in some embodiments, an intrinsic operating parameter of an acoustic sensor includes a parameter that any of a plurality of operating parameters that may be dynamically changed during operation of the acoustic sensor so that an acoustic measurement may be captured using operating parameters that are most appropriate for under prevailing environmental conditions and for a particular use case.

In various embodiments, an intrinsic operating parameter for an acoustic sensor includes various sonar resolutions corresponding to ability to detect and separate two different objects. For example, in some embodiments, an intrinsic operating parameter for an acoustic sensor includes an angular resolution associated with a receive transducer array and its associated beamformer in its ability to discern objects at different angles. The angular resolution corresponds to ability to see targets along path of the acoustic wave swath and is important in separating objects from one another. Generally, narrower acoustic beams provide for better angular resolution and therefore is more likely to distinguish between smaller targets along swath of beam.

In various embodiments, an intrinsic operating parameter for an acoustic sensor includes a pulse length corresponding to the extent of a transmitted pulse and measured in units of time. The pulse length is generally defined in terms of the pulse duration times the velocity of propagation of acoustic energy. However, the term pulse length is sometimes used in place of pulse duration, which refers to the (in milliseconds) of an individual pulse (ping) transmitted by a transducer. This is a nominal pulse length as selected on the echosounder. In various embodiments, an intrinsic operating parameter for an acoustic sensor also includes a pulse width corresponding to the width or narrowness (i.e., the active area) of acoustic beams. Acoustic pulses of equal length may have different pulse widths dependent upon the transmission medium (e.g., salt vs freshwater).

In various embodiments, an intrinsic operating parameter for an acoustic sensor includes a range resolution corresponding to ability to see targets along the path of the acoustic wave. The range resolution is generally dependent upon pulse width and acoustical frequency of transmitted acoustic beams. The frequencies of acoustic sensors range from infrasonic to above a megahertz. Generally, the lower frequencies have longer range, while the higher frequencies offer better resolution, and smaller size for a given directionality.

Range resolution may be increased by lowering pulse lengths. However, lowering pulse lengths will decrease an amount of energy being output into the surrounding medium and will limit the effective range of the acoustic sensor. Similarly, higher acoustic frequencies also limits range, as the surrounding medium (e.g., water) is heated from high frequency energy and thereby resulting in loss of range.

Acoustic sensors, such as echosounders and sonar, send out pulses of sound to locate objects. Sound travels in waves, not straight lines, and these waves expand in cones, getting wider and wider. The angle at which sound waves are focused depends on, for example, the operating frequency and physical dimensions of the acoustic sensor. High frequency acoustic sensors or an acoustic sensor with a large transducer will generate a narrow cone of energy. Further, in various embodiments, acoustic sensors can control the range of the sound wave cone by changing the scanning beam frequency. The choice of beam width depends on several considerations that can affect acoustic data collection or quality.

Wide beam scanning (e.g., 40° to 60° angle) allows for quickly scanning large areas and obtaining overall information regarding the measured area, but the accuracy and detail will be lower. Wide beam scanning is better suited for shallower waters because the cone covers a wider area, the shallower it scans. Further, wider beams allow for a greater sampling volume, an advantage when fish abundance is low, but are more sensitive to omni-directional background noise than narrow beams, making a narrow beam a better choice in noisy environments.

Narrow beam scanning (e.g., 10° to 20°) provides a more precise picture but covers a smaller area. Narrow beam scanning is better for finding the exact location of fish. That is, narrow beams (i.e., smaller half intensity beam width) increase horizontal resolution and improves the ability to separate echoes from individual fish 406. Narrow beam scanning is also better suited for deeper water, as the cone does not spread as wide. In general, a narrow beam requires a greater active area of transducer elements than does a wide beam at the same frequency.

In general, wide beams provide for lower depth penetration than narrow beams, higher horizontal extent than narrow beams, lower horizontal resolution at depth than narrow beams, lower near-field measurements than narrow beams, higher deadzone than narrow beams, and is better suited for higher ambient noise level environments than narrow beams. Further, with respect to acoustic frequencies, lower frequencies (e.g., below 20 kHz) has greater range due to lower rates of sound attenuation over a given distance but cannot distinguish small objects/fine detail. High to very high frequencies (e.g., above 100 kHz) provide improved resolution of fish and other small objects, but suffer from signal loss over distance from the source. These systems are most practical in shallow waters or for short range detection of objects near the source.

Factors such as speed of object movement within the underwater environment 404, density of underwater objects within the marine enclosure 408, movements in the pose of the acoustic sensor within the underwater environment 404 (e.g., swaying in the water current), ambient noises resulting from turbulent water flow during stormy weather conditions, and the like will influence whether captured acoustic measurements will be suitable for its intended purposes. As an example, in some embodiments, the acoustic sensor may be deployed in an underwater environment 404 subject to strong water current flow such that the first acoustic sensor system 202a experiences a large amount of extraneous noise in acoustic measurements. In some embodiments, the acoustic sensor may be deployed in an underwater environment such as within the marine enclosure 408 in which the subjects to be measured (e.g., fish 406) swim away from the acoustic sensors. In such circumstances, one or more of the trained models 414 may determine, based at least in part on positional data of the underwater objects and/or environmental data including ambient noise information, that one or more intrinsic operating parameters of the first acoustic sensor system 402a should be adjusted to increase a signal-to-noise ratio for subsequent acoustic measurements.

It should be recognized although various specific examples of intrinsic operating parameters are discussed herein for illustrative purposes, various intrinsic operating parameters may be dynamically reconfigured during sensor system operations without departing from the scope of this disclosure. As discussed above, in various embodiments, the trained models 414 include an output function representing learned acoustic sensor operating parameters. Such trained models 414 may be utilized by, for example, a sensor controller 418 to dynamically reconfigure the intrinsic operating parameters of the first acoustic sensor system 402a for capturing acoustic data with minimal operator input during operations. For example, in various embodiments, the first trained model 414a may be trained to learn or identify a combination of intrinsic operating parameters for the first acoustic sensor system 402a that enables capture of acoustic measurements having at least a minimum threshold quality level for the first use case. Similarly, the second trained model 414b may be trained to learn or identify a combination of intrinsic operating parameters for the first acoustic sensor system 402a that enables capture of acoustic measurements having at least a minimum threshold quality level for the second use case.

It should be appreciated that one or more of the various intrinsic operating parameters influence acoustic data measurements; further, changing such intrinsic operating parameters relative to each other may have complementary or antagonistic effects on data quality dependent upon various factors including but not limited to the prevailing underwater conditions (e.g., fish behavior/positioning as represented by underwater object parameters within acoustic data set 412a and/or environmental factors as represented by environmental parameters within environmental data set 412b), the particular use case for captured acoustic data is intended, and the like. Accordingly, after receiving input data indicative of underwater conditions within or proximate to the marine enclosure 408 (e.g., including acoustic data set 412a and/or environmental data set 412b), the first trained model 414a outputs a set of intrinsic operating parameters that is determined to provide, on balance, acoustic data of sufficient quality for its intended purposes for the first use case and under current prevailing conditions. In this manner, the dynamic sensor operating parameter reconfiguration of system 400 improves acoustic data capture with more reliable and accurate acoustic data capture techniques that allow for obtaining of improved data upon which farmers can better optimize precision aquaculture operations according to variations in the marine enclosure 408, which ultimately leads to increased yields and product quality.

In various embodiments, the sensor controller 418 further instructs the first acoustic sensor system 402a to obtain a set of one or more acoustic measurements in response to re-configuring the acoustic sensor system according to the determined sensor intrinsic operating parameters. The set of one or more acoustic measurements include acoustic measurements corresponding of the one or more underwater objects in the marine enclosure 408. As will be appreciated, marine enclosures 408 are generally positioned in environments 404 within which the farmer operator has limited to no ability to manually influence extrinsic variations during data gathering. For example, the underwater farming environment 404 is generally not a controlled environment in which environmental conditions or underwater object behavior may be manually adjusted easily to create improved conditions for acoustics capture.

Accordingly, in various embodiments, while extrinsic sensor parameters may be taken into account during analysis, the system 400 dynamically reconfigures intrinsic operating parameters without modifying extrinsic operating parameters. This is particularly beneficial for stationary sensor systems 404 without repositioning capabilities and/or for reducing disadvantages associated with physically repositioning sensors (e.g., more moving parts that increase possibilities of equipment malfunctions, disturbing the fish 406 which may negatively impact welfare and increase stress, disrupting normal farm operations, and the like).

In this manner, the dynamic sensor operating parameter reconfiguration of system 400 improves acoustic data capture with more reliable and accurate acoustic capture techniques that allow for obtaining of improved data upon which farmers can better optimize precision aquaculture operations according to variations in the marine enclosure 408, which ultimately leads to increased yields and product quality.

For context purposes, with respect to FIG. 5 and with continued reference to FIG. 4, illustrated is an example of dynamic intrinsic operating parameter reconfiguration of an acoustic sensor system within underwater environment 404. As illustrated in the two panel views 400a and 400b, a first acoustic sensor system 402a is positioned below the water surface and configured to capture acoustics data. Although the first acoustic sensor system 402a is shown in FIG. 5 to be positioned below the water surface, those skilled in the art will recognize that one or more sensors of the first acoustic sensor system 402a may be deployed under the water surface, at the water surface, above the water surface, remote to the locale at which the fish 406 are located, remote to the processing system 410, or any combination of the above without departing from the scope of this disclosure.

The one or more acoustic sensors are directed towards the surrounding environment 404, with each the hydroacoustic sensors are configured to capture acoustic data corresponding to the presence (or absence), abundance, distribution, size, and behavior of underwater objects (e.g., a population of fish 406 as illustrated in FIG. 4). In various embodiments, the one or more acoustic sensors monitor an individual fish, multiple fish, or an entire population of fish within the marine enclosure 408. Such acoustic data measurements may, for example, be used to identify fish positions within the water.

As illustrated in panel view 500a, the fish 406 are positioned within the marine enclosure 408 at a first time period t₁. In panel view 500a, the first acoustic sensor system 402a is configured to operate according to a first set of intrinsic operating parameters 502a such that acoustic beams 420 emitted by the first acoustic sensor system 402a covering a first search angle 422a. As shown, the first search angle 422a corresponding to the sound wave cone emitted by the first acoustic sensor system 402a in panel 500a encompasses a significant portion of the marine enclosure 508 and a majority of the fish 406. However, the first search angle 422a is deficient in that the wide acoustic beams 420 and long pulses are associated with low resolution.

In various embodiments, the processing system 410 receives one or more data sets 412 (e.g., acoustic data set 412a and environmental data set 412b) and stores the data sets 412 at the storage device 416 for processing. In various embodiments, the data sets 412 include data indicative of one or more conditions at one or more locations at which their respective sensor systems 402 are positioned. For example, in some embodiments, the acoustic data set 412a includes acoustics data representing any acoustic-related value or other measurable factor/characteristic that is representative of at least a portion of a data set describing the presence (or absence), abundance, distribution, size, and/or behavior of underwater objects (e.g., a population of fish 406 as illustrated in panel view 500a of FIG. 5). In various embodiments, the data sets 412 also include environmental data set 412b includes environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosure 408.

In the context of FIG. 5, dynamic conditions, such as a change in the environment 404 around the first acoustic sensor system 402a (e.g., due to movement of the fish 406 within the marine enclosure 408) and/or the second sensor system 402b, impact the operations and accuracy of sensor systems. In particular, as illustrated in panel view 500a, the first search angle 422a is deficient in that the wide acoustic beams 420 and long pulses are associated with low resolution, which is less than desirable in situations requiring a more granular perspective of the marine enclosure. For example, a given region of water (e.g., first pulse volume 504a) insonifed by the first acoustic sensor system 402a pings more fish 406 but is less able to distinguish between different targets in the beam swath. That is, fish 406 within the first pulse volume 504 (delineated with dashed lines) cannot be resolved separately due to the increased number of fish within the volume when the pulse duration is longer and when the acoustic beam is wider.

As discussed above, the data sets 412 including the acoustic data set 412a and/or the environmental data set 412b are provided as input to one or more trained models 414 (e.g., a first trained model 414a for a first use case and at least a second trained model 414b for a second use case). In various embodiments, the first trained model 414a is trained to learn or identify a combination of intrinsic operating parameters for the first acoustic sensor system 402a that enables capture of acoustic data having at least a minimum threshold quality level for the first use case. For context purposes, in some embodiments, the first trained model 214a for the first use case may include a model trained to receive the acoustic data for estimating a number of individual fish and combined biomass within an area of the marine enclosure 408. In some embodiments, the second trained model 414b for the second use case may include a model trained to receive acoustic data for monitoring aggregate population dynamics, such as for determining whether population behavior is indicative of certain conditions (e.g., hunger, sickness, and the like).

In various embodiments, the trained models 414 include an output function representing learned acoustic sensor operating parameters. Such trained models 414 may be utilized by, for example, the sensor controller 418 to dynamically reconfigure the intrinsic operating parameters of the first acoustic sensor system 402a for capturing acoustic data with minimal operator input during operations. For example, in various embodiments, the first trained model 414a may be trained to learn or identify a combination of intrinsic operating parameters for the first acoustic sensor system 402a that enables capture of acoustic data having at least a minimum threshold quality level for the first use case.

Accordingly, after receiving input data indicative of underwater conditions within or proximate to the marine enclosure 408 (e.g., including acoustic data set 412a and/or environmental data set 412b), the first trained model 414a determines and outputs a set of intrinsic operating parameters (as represented by the second set of intrinsic operating parameters 502b in FIG. 5) that is determined to provide improvement of acoustic data quality under prevailing conditions (e.g., fish position within the marine enclosure 408) and further for the first use case (e.g., estimating a number of individual fish and combined biomass within an area).

In one embodiment, as illustrated in panel view 500b, the sensor controller 418 configures the first acoustic sensor system 402a according to the determined second set of intrinsic operating parameters 502b such that one or more intrinsic operating parameters are changed relative to the first set of intrinsic operating parameters 502a for a second time period t₂. In general, the second time period t₂ includes any time interval subsequent to that of the first time period t₁ and may be of any time duration. Thus, in some embodiments, the acoustic sensor reconfiguration described herein with respect to FIGS. 4 and 5 may be performed on a periodic basis in accordance with a predetermined schedule. In other embodiments, the prevailing conditions of the environment 404 may be continuously monitored such that the first acoustic sensor system 402 is dynamically reconfigured in close to real-time as appropriate for particular use cases and in response to data represented within data sets 412.

As illustrated in panel view 500b, the fish 206 are positioned within the marine enclosure 208 at approximately the same positions as they were in panel view 500a for the first time period t₁. However, in panel view 500b, the acoustic sensor system 502a has been reconfigured according to the determined second set of intrinsic operating parameters 502b such that acoustic beams 420 emitted by the first acoustic sensor system 402a covers a second search angle 422b. As shown, the second search angle 422b corresponding to the sound wave cone emitted by the first acoustic sensor system 402a in panel 500b encompasses a smaller portion of the marine enclosure 508 and fewer of the fish 406 relative to panel view 500a. Accordingly, a given region of water (e.g., second pulse volume 504b) insonifed by the first acoustic sensor system 402a pings fewer fish 406 but is able to distinguish between an increased number of targets in the beam swath.

In various embodiments, the sensor controller 418 instructs the acoustic sensor system 402a to obtain a set of one or more acoustic measurements in response to re-configuring the acoustic sensor system according to the determined sensor intrinsic operating parameters. Thus, the increased angular resolution associated with the sound wave cone emitted by the first acoustic sensor system 402a in panel 500b results in capture of different acoustics data for the same pose and substantially the same scene, shot at the first time period t₁ for panel view 500a (left) and the second time period t₂ for panel view 500b (right). In particular, the second search angle 422b and its other associated second set of intrinsic operating parameters 502b is able to distinguish between individual fish 406 in second pulse volume 504b (as opposed to, for example, panel view 500a in which two or more fish within the first pulse volume 504a are captured as a single mass).

Accordingly, in various embodiments, the processing system 410 dynamically reconfigures intrinsic operating parameters without modifying extrinsic operating parameters (although extrinsic camera parameters may be taken into account during analysis and processing of data sets 412 by the trained models). In other embodiments, the processing system 410 changes a pose of the acoustic sensor system 402a without physically repositioning (e.g., translational movement within the environment 404) the sensor system away from its three-dimensional position within the marine enclosure 208. For example, in some embodiments, the processing system 410 may reconfigure the pose (not shown) by changing the external orientation (e.g., rotational movement of the acoustic sensor housing about one or more axes) of the acoustic sensor system 402a relative to the environment 404. The dynamic reconfiguration of intrinsic operating parameters is particularly beneficial for stationary sensor systems 402 without repositioning capabilities and/or for reducing disadvantages associated with physically repositioning sensors. In this manner, the quality of captured acoustic data is improved in underwater farming environments 404 that are generally not controlled environments in which environmental conditions or underwater object behavior may be manually adjusted easily to create improved conditions for acoustic data capture.

It should be recognized that FIG. 5 is described primarily in the context of dynamic reconfiguration of acoustic sensor intrinsic parameters based on the underwater object parameter of fish position within the water column for ease of illustration and description. However, those skilled in the art will recognize that the acoustic sensors for FIGS. 4 and 5 may be dynamically reconfigured based on data indicative of any number of underwater object parameters and/or environmental parameters. It should further be recognized that although FIG. 5 is described in the specific context of an acoustic sensor, the one or more sensor systems of FIG. 5 may include any number of and any combination of various acoustic and/or environmental sensors without departing from the scope of this disclosure.

Additionally, although dynamic sensor operating parameter reconfiguration is described with respect to FIGS. 4 and 4 primarily in the context of below-water acoustic sensors and below-water environmental sensors, data may be collected by any of a variety of imaging and non-imaging sensors. By way of non-limiting examples, in various embodiments, the sensor systems may include various sensors local to the site at which the fish are located (e.g., underwater telemetry devices and sensors), sensors remote to the fish site (e.g., satellite-based weather sensors such as scanning radiometers), various environmental monitoring sensors, active sensors (e.g., active sonar), passive sensors (e.g., passive acoustic microphone arrays), echo sounders, photo-sensors, ambient light detectors, accelerometers for measuring wave properties, salinity sensors, thermal sensors, infrared sensors, chemical detectors, temperature gauges, or any other sensor configured to measure data. It should be further recognized that, in various embodiments, the sensor systems utilized herein are not limited to below-water sensors and may include combinations of a plurality of sensors at different locations. It should also be recognized that, in various embodiments, the sensor systems utilized herein are not limited to single sensor-type configurations. For example, in various embodiments, the sensor systems may include two different sensor systems positioned at different locations (e.g., under water and above water) and/or a plurality of differing environmental sensors.

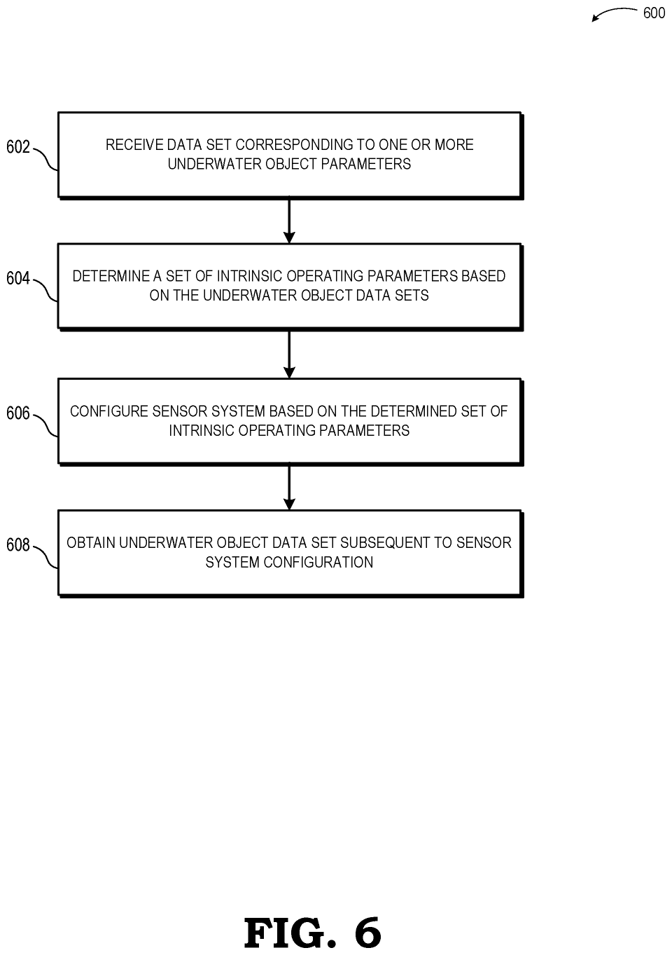

Referring now to FIG. 6, illustrated is a flow diagram of a method 600 for implementing dynamic reconfiguration of sensor operating parameters in accordance with some embodiments. For ease of illustration and description, the method 600 is described below with reference to and in an example context of the systems 100, 200, and 400 of FIG. 1, FIG. 2, and FIG. 4, respectively. However, the method 600 is not limited to these example contexts, but instead may be employed for any of a variety of possible system configurations using the guidelines provided herein.

The method begins at block 602 with the receipt by a processing system of data indicative of one or more underwater object parameters corresponding to one or more underwater objects within a marine enclosure. In various embodiments, the operations of block 602 include providing one or more sensor data sets via a wireless or wired communications link to a processing system for model training and subsequent use as input into trained models. For example, in the context of FIG. 1, the sensor systems 202 communicate at least the first sensor data set 112a and the second sensor data set 112b to the processing system 110 for storage, processing, and the like.

As illustrated in FIG. 1, the trained models 114 are executed locally using the same processing system 110 at which the first sensor data set 112a is stored. Accordingly, the first sensor data set 112a may be so provided to the trained models 114 by transmitting one or more data structures to processors 110 via a wireless or wired link (e.g., communications bus) for processing. It should be noted that the first sensor data set 112a and the trained models 114 do not need to be stored and/or processed at the same device or system. Accordingly, in various embodiments, the providing of the first sensor data set 112a and its receipt by the trained model for the operations of block 602 may be implemented in any distributed computing configuration (e.g., such as amongst the processing system 110, network 120, remote platforms 122, external resources 124, and server 126 of FIG. 1).

In at least one embodiment, and with reference to FIG. 2, the first sensor data set includes data corresponding to image data set 212a includes image data representing any image-related value or other measurable factor/characteristic that is representative of at least a portion of a data set that describes the presence (or absence), abundance, distribution, size, and/or behavior of underwater objects (e.g., a population of fish 206 as illustrated in FIG. 2). With respect to image data, the image data set 212a may also include camera images capturing measurements representative of the relative and/or absolute locations of individual fish of the population of fish 206 within the environment 204. Such image data may be indicative of one or more underwater object parameters corresponding to one or more underwater objects (e.g., fish 206) within a marine enclosure 208.

In other embodiments, and with reference to FIG. 4, the first sensor data set includes data corresponding to acoustic data set 412a including acoustic data representing any acoustic-related value or other measurable factor/characteristic that is representative of at least a portion of a data set that describes the presence (or absence), abundance, distribution, size, and/or behavior of underwater objects (e.g., a population of fish 406 as illustrated in FIG. 4). With respect to acoustic data, the acoustic data set 412a may also include acoustic measurements capturing measurements representative of the relative and/or absolute locations of individual and/or aggregates of the population of fish 406 within the environment 404. Such acoustic data may be indicative of one or more underwater object parameters corresponding to one or more underwater objects (e.g., fish 406) within the marine enclosure 408.

Further, in various embodiments described with reference to FIGS. 1-5, the operations of block 602 may also include receiving data indicative of one or more environmental conditions associated with the marine enclosure. As previously described, the processing system 110 receives one or more sensor data sets 112 (e.g., first sensor data set 112a and the environmental sensor data set 112b) and stores the sensor data sets 112 at the storage device 116 for processing. In various embodiments, the sensor data sets 112 include data indicative of one or more conditions at one or more locations at which their respective sensor systems 102 are positioned. For example, the environmental data set 212b includes environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosure 208. For example, in some embodiments, the environmental sensors of the second sensor system 202b includes an ambient light sensor or other photodetector configured to sense or otherwise measure an amount of ambient light present within the environment local to the sensor. In various embodiments, the environmental sensors of the second sensor system 202b includes a turbidity sensor configured to measure an amount of light scattered by suspended solids in the water. Turbidity is a measure of the degree to which water (or other liquids) changes in level of its transparency due to the presence of suspended particulates (e.g., by measuring an amount of light transmitted through the water). In general, the more total suspended particulates or solids in water, the higher the turbidity and therefore murkier the water appears.

The method 600 continues at block 404 with the determination of a set of intrinsic operating parameters for a sensor system at a position within the marine enclosure based at least in part on the data indicative of one or more underwater object parameters. With respect to FIGS. 2-3, in various embodiments, image data (which in various embodiments includes at least a subset of image data captured by one or more cameras of the first image sensor system 202a) and environmental data (which in various embodiments includes at least a subset of environmental data captured by one or more environmental sensors of the second sensor system 202b) is provided as training data to generate trained models 214 using machine learning techniques and neural networks.

Dynamic conditions, such as a change in the environment 204 around the first image sensor system 202a and/or the second sensor system 202b, impact the operations and accuracy of sensor systems. In various embodiments, machine learning techniques may be used to determine various relationships between training images and the contextual image data to learn or identify relationships (e.g., as embodied in the trained models 214) between image data and sensor operating parameters associated with capturing desirable sensor measurements (e.g., an image frame meeting a predetermined minimum quality threshold for one or more intended use cases, an image frame capturing relevant info from an underwater scene, and the like). In various embodiments, the trained models 214 include an output function representing learned image sensor operating parameters.

In various embodiments, the first trained model 214a may be trained to learn or identify a combination of intrinsic operating parameters for the first image sensor system 202a that enables capture of images having at least a minimum threshold quality level for the first use case. Similarly, the second trained model 214b may be trained to learn or identify a combination of intrinsic operating parameters for the first acoustic sensor system 202a that enables capture of images having at least a minimum threshold quality level for the second use case.

Referring now to FIG. 3 and with continued reference to FIG. 2, first depth of field 308a is deficient in that a majority of the fish 206 are positioned outside the first depth of field 308a (e.g., outside of the range of acceptable sharpness) and therefore would appear out of focus within captured imagery of the image data set 212a. Accordingly, after receiving input data indicative of underwater conditions within or proximate to the marine enclosure 208 (e.g., including image data set 212a and/or environmental data set 212b), the first trained model 214a determines and outputs a set of intrinsic operating parameters (as represented by the second set of intrinsic operating parameters 302b in FIG. 3) that is determined to provide improvement of image data quality under prevailing conditions (e.g., fish position within the marine enclosure 208) and further for the first use case (e.g., monitoring aggregate population dynamics). Additionally, FIGS. 4-5 describe similar operations of determining intrinsic operating parameters based on data indicative of one or more underwater object parameters.

Subsequently, at block 606, the processing system configures the sensor system according to the determined set of intrinsic operating parameters by changing at least one intrinsic operating parameter of the sensor system in response to the data indicative of one or more underwater object parameters. For example, with respect to FIG. 3, after receiving input data indicative of underwater conditions within or proximate to the marine enclosure 208 (e.g., including image data set 212a and/or environmental data set 212b), the first trained model 214a determines and outputs a set of intrinsic operating parameters (as represented by the second set of intrinsic operating parameters 302b in FIG. 3) that is determined to provide improvement of image data quality under prevailing conditions (e.g., fish position within the marine enclosure 208) and further for the first use case (e.g., monitoring aggregate population dynamics). The sensor controller 218 then configures the first image sensor system 202a according to the determined second set of intrinsic operating parameters 302b such that one or more intrinsic operating parameters are changed relative to the first set of intrinsic operating parameters 302a for a second time period t₂.

At block 408, the processing system obtains an underwater object data set in response to configuring the sensor system according to the determined set of intrinsic operating parameters. In various embodiments, the underwater object data set includes one or more sensor measurements of the one or more underwater objects within the marine enclosure. For example, in various embodiments, the processing system 210 of FIG. 2 includes a sensor controller 218 that instructs the first image sensor system 202a to obtain a set of one or more images in response to re-configuring the image sensor system according to the determined sensor intrinsic operating parameters. The set of one or more images include images of the one or more underwater objects in the marine enclosure 208.

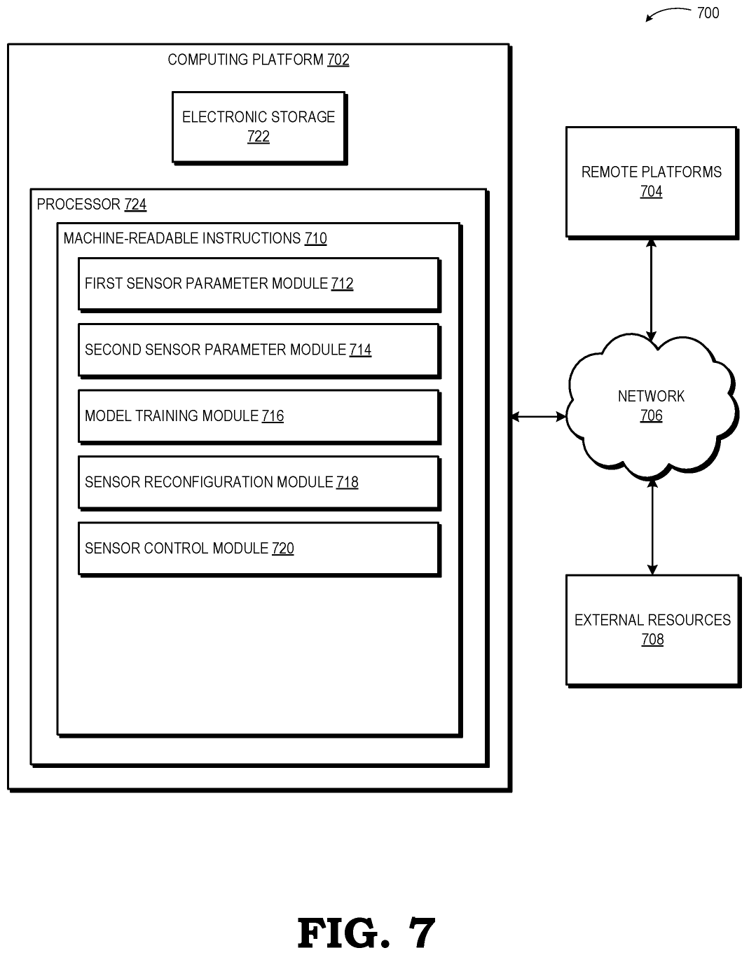

FIG. 7 is a block diagram illustrating a system 700 configured to provide dynamic sensor system reconfiguration in accordance with some embodiments. In some embodiments, the system 700 includes one or more computing platforms 702. The computing platform(s) 702 may be configured to communicate with one or more remote platforms 704 according to a client/server architecture, a peer-to-peer architecture, and/or other architectures via a network 706. Remote platform(s) 704 may be configured to communicate with other remote platforms via computing platform(s) 702 and/or according to a client/server architecture, a peer-to-peer architecture, and/or other architectures via the network 706. Users may access system 700 via remote platform(s) 704. A given remote platform 704 may include one or more processors configured to execute computer program modules.

The computer program modules may be configured to enable an expert or user associated with the given remote platform 704 to interface with system 700 and/or one or more external resource(s) 708, and/or provide other functionality attributed herein to remote platform(s) 704. By way of non-limiting example, a given remote platform 704 and/or a given computing platform 702 may include one or more of a server, a desktop computer, a laptop computer, a handheld computer, a tablet computing platform, a NetBook, a Smartphone, a gaming console, and/or other computing platforms.

In some implementations, the computing platform(s) 702, remote platform(s) 704, and/or one or more external resource(s) 706 may be operatively linked via one or more electronic communication links. For example, such electronic communication links may be established, at least in part, via a network 706 such as the Internet and/or other networks. It will be appreciated that this is not intended to be limiting, and that the scope of this disclosure includes implementations in which computing platform(s) 702, remote platform(s) 704, and/or one or more external resource(s) 708 may be operatively linked via some other communication media. External resource(s) 708 may include sources of information outside of system 700, external entities participating with system 700, and/or other resources. In some implementations, some or all of the functionality attributed herein to external resources 708 may be provided by resources included in system 700.

In various embodiments, the computing platform(s) 702 are configured by machine-readable instructions 710 including one or more instruction modules. In some embodiments, the instruction modules include computer program modules for implementing the various operations discussed herein (such as the operations previously discussed with respect to FIG. 6).

For purposes of reference, the instruction modules include one or more of a first sensor parameter module 712, a second sensor parameter module 714, a model training module 716, a sensor reconfiguration module 718, and a sensor control module 720. Each of these modules may be implemented as one or more separate software programs, or one or more of these modules may be implemented in the same software program or set of software programs. Moreover, while referenced as separate modules based on their overall functionality, it will be appreciated that the functionality ascribed to any given model may be distributed over more than one software program. For example, one software program may handle a subset of the functionality of the first sensor parameter module 712 while another software program handles another subset of the functionality of the second sensor parameter module 714.

In various embodiments, the first sensor parameter module 712 generally represents executable instructions configured to receive a first sensor parameter data set. With reference to FIGS. 1-6, in various embodiments, the first sensor parameter module 712 receives sensor data including the first sensor data set via a wireless or wired communications link for storage, further processing, and/or distribution to other modules of the system 700. For example, in the context of FIG. 2, the sensor system 202 communicate at least the first image data set 212a including image data representing any image-related value or other measurable factor/characteristic that is representative of at least a portion of a data set that describes the presence (or absence), abundance, distribution, size, and/or behavior of underwater objects (e.g., a population of fish 206 as illustrated in FIG. 2). In the context of FIG. 4, the sensor system 402 communicate at least the acoustic data set 412a includes acoustic data representing any acoustic-related value or other measurable factor/characteristic that is representative of at least a portion of a data set that describes the presence (or absence), abundance, distribution, size, and/or behavior of underwater objects (e.g., a population of fish 406 as illustrated in FIG. 4). In various embodiments, such first sensor parameter data sets may be processed by the first sensor parameter module 710 to format or package the data set for use by, for example, training or as input into machine-learning models.

In various embodiments, the second sensor parameter module 714 generally represents executable instructions configured to receive a second sensor parameter data set. With reference to FIGS. 1-6, in various embodiments, the second sensor parameter module 714 receives sensor data including the second sensor parameter data set via a wireless or wired communications link for storage, further processing, and/or distribution to other modules of the system 700. For example, in the context of FIGS. 2 and 4, the sensor systems 202b, 402b communicate at least the environmental data set 212b, 412b including environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosures 208, 408.

In various embodiments, the first model training module 716 generally represents executable instructions configured to receive at least a subset of the first sensor parameter data set from the sensor parameter module 712 and generate a trained model for a first use case. With reference to FIGS. 1-6, in various embodiments, the first model training module 716 receives one or more data sets embodying parameters related to underwater object parameters and environmental parameters that may influence the accuracy of sensor system operations. For example, in the context of FIG. 2, the first model training module 716 receives one or more of more data sets 212 (e.g., image data set 212a and environmental data set 212b) and applies various machine learning techniques to determine various relationships between training images and the contextual image data to learn or identify relationships (e.g., as embodied in the trained models 214) between image data and sensor operating parameters associated with capturing desirable sensor measurements (e.g., an image frame meeting a predetermined minimum quality threshold for one or more intended use cases, an image frame capturing relevant info from an underwater scene, and the like).

For example, such learned relationships may include a learned function between underwater object parameters (e.g., physical location of fish 206 within the marine enclosure 208 such as represented within image data set 212a), environmental parameters (e.g., the turbidity of a liquid medium such as represented within environmental data set 212b), one or more image labels/annotations, image metadata, and other contextual image data to one or more sensor operating parameters. In particular, the first model training module 716 generates a first trained model 214a for a first use case. In various embodiments, the first trained model 214a may be trained to learn or identify a combination of intrinsic operating parameters for the first image sensor system 202a that enables capture of images having at least a minimum threshold quality level for the first use case, such use cases having been described in more detail above.

In the context of FIG. 4, the first model training module 716 receives one or more of more data sets 412 (e.g., acoustic data set 412a and environmental data set 412b) and applies various machine learning techniques to determine various relationships between training images and the contextual acoustics data to learn or identify relationships (e.g., as embodied in the trained models 414) between acoustic data and sensor operating parameters associated with capturing desirable sensor measurements (e.g., acoustic measurements meeting a predetermined minimum quality threshold for one or more intended use cases, acoustic measurements capturing relevant info from an underwater scene, and the like).

For example, such learned relationships may include a learned function between underwater object parameters (e.g., physical location of fish 406 within the marine enclosure 408 such as represented within acoustic data set 412a), environmental parameters (e.g., ambient noise levels such as represented within environmental data set 412b), one or more acoustic labels/annotations, acoustic metadata, and other contextual acoustic data to one or more sensor operating parameters. In particular, the first model training module 716 generates a first trained model 414a for a first use case. In various embodiments, the first trained model 414a may be trained to learn or identify a combination of intrinsic operating parameters for the first acoustic sensor system 402a that enables capture of acoustic data having at least a minimum threshold quality level for the first use case, such use cases having been described in more detail above.

In various embodiments, the second model training module 718 generally represents executable instructions configured to receive at least a subset of the first sensor parameter data set from the sensor parameter module 712 and generate a trained model for a second use case. With reference to FIGS. 1-6, in various embodiments, the second model training module 718 receives one or more data sets embodying parameters related to underwater object parameters and environmental parameters that may influence the accuracy of sensor system operations. For example, in the context of FIG. 2, the second model training module 718 receives one or more of more data sets 212 (e.g., image data set 212a and environmental data set 212b) and applies various machine learning techniques to determine various relationships between training images and the contextual image data to learn or identify relationships (e.g., as embodied in the trained models 214) between image data and sensor operating parameters associated with capturing desirable sensor measurements (e.g., an image frame meeting a predetermined minimum quality threshold for one or more intended use cases, an image frame capturing relevant info from an underwater scene, and the like).

For example, such learned relationships may include a learned function between underwater object parameters (e.g., physical location of fish 206 within the marine enclosure 208 such as represented within image data set 212a), environmental parameters (e.g., the turbidity of a liquid medium such as represented within environmental data set 212b), one or more image labels/annotations, image metadata, and other contextual image data to one or more sensor operating parameters. In particular, the second model training module 718 generates a second trained model 214b for a second use case. In various embodiments, the second trained model 214b may be trained to learn or identify a combination of intrinsic operating parameters for the first image sensor system 202a that enables capture of images having at least a minimum threshold quality level for the second use case, such use cases having been described in more detail above.

In the context of FIG. 4, the second model training module 718 receives one or more of more data sets 412 (e.g., acoustic data set 412a and environmental data set 412b) and applies various machine learning techniques to determine various relationships between training images and the contextual acoustics data to learn or identify relationships (e.g., as embodied in the trained models 414) between acoustic data and sensor operating parameters associated with capturing desirable sensor measurements (e.g., acoustic measurements meeting a predetermined minimum quality threshold for one or more intended use cases, acoustic measurements capturing relevant info from an underwater scene, and the like).

For example, such learned relationships may include a learned function between underwater object parameters (e.g., physical location of fish 406 within the marine enclosure 408 such as represented within acoustic data set 412a), environmental parameters (e.g., ambient noise levels such as represented within environmental data set 412b), one or more acoustic labels/annotations, acoustic metadata, and other contextual acoustic data to one or more sensor operating parameters. In particular, the second model training module 718 generates a second trained model 414b for a second use case. In various embodiments, the second trained model 414b may be trained to learn or identify a combination of intrinsic operating parameters for the first acoustic sensor system 402a that enables capture of acoustic data having at least a minimum threshold quality level for the second use case, such use cases having been described in more detail above.

In various embodiments, the sensor control module 720 generally represents executable instructions configured to instruct the sensor systems according to the determined sensor intrinsic operating parameters as output by the trained models of the first model training module 716 and the second model training module 718. For example, in the context of FIGS. 2 and 3, the sensor control module 720 receives a set of intrinsic operating parameters (as represented by the second set of intrinsic operating parameters 302b in FIG. 3) that is determined to provide improvement of image data quality under prevailing conditions (e.g., fish position within the marine enclosure 208) and further for the first use case (e.g., monitoring aggregate population dynamics). Subsequently, the sensor control module 720 configures the first image sensor system 202a according to the determined second set of intrinsic operating parameters 302b such that one or more intrinsic operating parameters are changed relative to the first set of intrinsic operating parameters 302a for a second time period t₂. Additionally, the sensor control module 720 instructs the image sensor system 202a to obtain a set of one or more images in response to re-configuring the image sensor system according to the determined sensor intrinsic operating parameters.

The system 700 also includes an electronic storage 722 including non-transitory storage media that electronically stores information. The electronic storage media of electronic storage 722 may include one or both of system storage that is provided integrally (i.e., substantially non-removable) with computing platform(s) 702 and/or removable storage that is removably connectable to computing platform(s) 702 via, for example, a port (e.g., a USB port, a firewire port, etc.) or a drive (e.g., a disk drive, etc.). Electronic storage 722 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 722 may include one or more virtual storage resources (e.g., cloud storage, a virtual private network, and/or other virtual storage resources). Electronic storage 722 may store software algorithms, information determined by processor(s) 724, information received from computing platform(s) 702, information received from remote platform(s) 704, and/or other information that enables computing platform(s) 702 to function as described herein.

Processor(s) 724 may be configured to provide information processing capabilities in computing platform(s) 702. As such, processor(s) 724 may include one or more of a digital processor, an analog processor, a digital circuit designed to process information, an analog circuit designed to process information, a state machine, and/or other mechanisms for electronically processing information. Although processor(s) 724 is shown in FIG. 7 as a single entity, this is for illustrative purposes only. In some implementations, processor(s) 724 may include a plurality of processing units. These processing units may be physically located within the same device, or processor(s) 724 may represent processing functionality of a plurality of devices operating in coordination. Processor(s) 724 may be configured to execute modules 712, 714, 716, 718, and/or 720, and/or other modules. Processor(s) 724 may be configured to execute modules 712, 714, 716, 718, and/or 720, and/or other modules by software; hardware; firmware; some combination of software, hardware, and/or firmware; and/or other mechanisms for configuring processing capabilities on processor(s) 724. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 712, 714, 716, 718, and/or 720 are illustrated in FIG. 7 as being implemented within a single processing unit, in implementations in which processor(s) 724 includes multiple processing units, one or more of modules 712, 714, 716, 718, and/or 720 may be implemented remotely from the other modules. The description of the functionality provided by the different modules 712, 714, 716, 718, and/or 720 described below is for illustrative purposes, and is not intended to be limiting, as any of modules 712, 714, 716, 718, and/or 720 may provide more or less functionality than is described. For example, one or more of modules 712, 714, 716, 718, and/or 720 may be eliminated, and some or all of its functionality may be provided by other ones of modules 712, 714, 716, 718, and/or 720. As another example, processor(s) 724 may be configured to execute one or more additional modules that may perform some or all of the functionality attributed below to one of modules 712, 714, 716, 718, and/or 720.

Although primarily discussed here in the context of aquaculture as it relates to the generation of sensor data with respect to fish 106, those skilled in the art will recognize that the techniques described herein may be applied to any aquatic, aquaculture species such as shellfish, crustaceans, bivalves, finfish, and the like without departing from the scope of this disclosure. Further, those skilled in the art will recognize that the techniques described herein may also be applied to dynamically reconfiguring sensor systems for any husbandry animal that is reared in an environment in which sensor systems are deployed (e.g., not in an underwater environment), and for which the sensor systems will vary in accuracy of measurements depending on environmental conditions, population movement away from sensor capture areas, and the like.

Accordingly, as discussed herein, FIGS. 1-7 describe techniques that improve the precision and accuracy of sensor measurements by dynamically reconfiguring of sensor system operating parameters during operations. In various embodiments, through the use of machine-learning techniques and neural networks, the systems described herein generate learned models that are unique to one or more intended use cases corresponding to different applications or activities at a farm site. Based on sensor data, the systems may use observed conditions at the farm sites to respond to environmental conditions/fish behavior relative to the sensors and adjust sensor intrinsic operating parameters so that obtained sensor measurements are of improved quality (which is dependent upon the particular use cases) without requiring physical repositioning of sensors.

The above-noted aspects and implementations further described in this specification may offer several advantages, including providing an efficient manner for automated and dynamic monitoring of fish to improve the results of aquaculture operations, including feeding observations and health monitoring. In various embodiments, the dynamic sensor reconfiguration of intrinsic operating parameters is customized for particular activities. For example, in one embodiment, obtained images from image sensors is used to monitor conditions in marine enclosures and identify hunger levels based on swimming patterns or locations within the marine enclosure. A feed controller may be turned on or off (or feeding rates ramped up or down) based on image-identified behaviors to reduce over- and under-feeding.

As will be appreciated, feeding-related use cases require images of different properties than, for example, another embodiment in which images are used to monitor track fish individuals and/or fish health by identifying and counting lice on each individual fish. Lice counting will generally require a higher resolution image in which more pixels are dedicated to each individual fish, something that would lose context of overall fish behavior and position within the marine enclosure (and therefore be bad quality data) if used in feeding applications. Additionally, because the sensors are capturing more relevant data for its intended uses, the dynamic reconfiguring of sensor system operating parameters during operations improves efficiency for computer, storage, and network resources. This is particularly evident in the resource-constrained environments of aquaculture operations, which are often compute limited and further exhibit network bandwidth constraints or intermittent connectivity due to the remote locales of the farms.

In some embodiments, certain aspects of the techniques described above may implemented by one or more processors of a processing system executing software. The software includes one or more sets of executable instructions stored or otherwise tangibly embodied on a non-transitory computer readable storage medium. A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments, meaning that the particular feature, function, structure, or characteristic being described is included in at least one embodiment of the techniques and concepts discussed herein. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Further, although the concepts have been described herein with reference to various embodiments, references to embodiments do not necessarily all refer to the same embodiment. Similarly, the embodiments referred to herein also are not necessarily mutually exclusive.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
receiving, at an electronic device, data indicative of one or more underwater object parameters corresponding to one or more underwater objects within a marine enclosure;
determining, by the electronic device, a set of intrinsic operating parameters for a sensor system at a position within the marine enclosure based at least in part on the data indicative of one or more underwater object parameters;
configuring, by the electronic device, the sensor system according to the determined set of intrinsic operating parameters by changing at least one intrinsic operating parameter of the sensor system in response to the data indicative of one or more underwater object parameters; and
obtaining, by the electronic device, an underwater object data set in response to configuring the sensor system according to the determined set of intrinsic operating parameters, wherein the underwater object data set includes one or more sensor measurements of the one or more underwater objects within the marine enclosure.

2. The method of claim 1, wherein configuring the sensor system according to the determined set of intrinsic operating parameters further comprises:
changing the at least one intrinsic operating parameter of the sensor system without physically repositioning the sensor system away from the position within the marine enclosure.

3. The method of claim 2, wherein changing the at least one parameter of the sensor system further comprises:
changing a pose of the sensor system without physically repositioning the sensor system away from the position within the marine enclosure.

4. The method of claim 1, wherein receiving data indicative of one or more underwater object parameters comprises one or more of:
receiving data indicating a schooling behavior of fish;
receiving data indicating a swimming behavior of fish;
receiving data corresponding to a physical location of the one or more underwater objects;
receiving data corresponding to an identification of an individual fish; and
receiving data indicating a distance of the one or more underwater objects from the sensor system.

5. The method of claim 1, further comprising:
receiving, at the electronic device, data indicative of one or more environmental conditions associated with the marine enclosure; and
determining, by the electronic device, the set of intrinsic operating parameters for the sensor system based at least in part on the data indicative of one or more environmental conditions.

6. The method of claim 1, wherein changing the at least one intrinsic operating parameter of the sensor system comprises one or more of:
changing an aperture size of an image sensor of the sensor system;
changing a shutter speed of the image sensor;
changing an ISO value of the image sensor;
changing an exposure setting of the image sensor;
changing a depth of field of the image sensor;
changing an optical zoom of the image sensor;
changing a field of view of the image sensor;
changing a lens shift position of the image sensor; and
changing a lens tilt angle of the image sensor.

7. The method of claim 1, wherein changing the at least one intrinsic operating parameter of the sensor system comprises one or more of:
changing a beam width of an acoustic sensor of the sensor system;
changing an angular resolution of the acoustic sensor;
changing a range resolution of the acoustic sensor;
changing a pulse length of the acoustic sensor;
changing a pulse width of the acoustic sensor;
changing an operating frequency of the acoustic sensor;
changing a beam scanning mode of the acoustic sensor;
changing a receiver sensitivity of the acoustic sensor; and
changing an acoustic source strength of the acoustic sensor.

8. A non-transitory computer readable medium embodying a set of executable instructions, the set of executable instructions to manipulate at least one processor to:
receive, at an electronic device, data indicative of one or more underwater object parameters corresponding to one or more underwater objects within a marine enclosure;
determine, by the electronic device, a set of intrinsic operating parameters for a sensor system at a position within the marine enclosure based at least in part on the data indicative of one or more underwater object parameters;
configure, by the electronic device, the sensor system according to the determined set of intrinsic operating parameters by changing at least one intrinsic operating parameter of the sensor system in response to the data indicative of one or more underwater object parameters; and
obtain, by the electronic device, an underwater object data set in response to configuring the sensor system according to the determined set of intrinsic operating parameters, wherein the underwater object data set includes one or more sensor measurements of the one or more underwater objects within the marine enclosure.

9. The non-transitory computer readable medium of claim 8, further embodying executable instructions to manipulate at least one processor to:
change the at least one intrinsic operating parameter of the sensor system without physically repositioning the sensor system away from the position within the marine enclosure.

10. The non-transitory computer readable medium of claim 9, further embodying executable instructions to manipulate at least one processor to:
change a pose of the sensor system without physically repositioning the sensor system away from the position within the marine enclosure.

11. The non-transitory computer readable medium of claim 8, further embodying executable instructions to manipulate at least one processor to:
receive data indicating one or more of a schooling behavior of fish, a swimming behavior of fish, a physical location of the one or more underwater objects, an identification of an individual fish, and a distance of the one or more underwater objects from the sensor system.

12. The non-transitory computer readable medium of claim 8, further embodying executable instructions to manipulate at least one processor to:
receive, at the electronic device, data indicative of one or more environmental conditions associated with the marine enclosure; and
determine, by the electronic device, the set of intrinsic operating parameters for the sensor system based at least in part on the data indicative of one or more environmental conditions.

13. The non-transitory computer readable medium of claim 8, further embodying executable instructions to manipulate at least one processor to:
change one or more intrinsic operating parameters including an aperture size of an image sensor of the sensor system, a shutter speed of the image sensor, an ISO value of the image sensor, an exposure setting of the image sensor, a depth of field of the image sensor, an optical zoom of the image sensor; a field of view of the image sensor, changing a lens shift position of the image sensor, and a lens tilt angle of the image sensor.

14. The non-transitory computer readable medium of claim 8, further embodying executable instructions to manipulate at least one processor to:
change one or more intrinsic operating parameters including a beam width of an acoustic sensor of the sensor system; an angular resolution of the acoustic sensor, a range resolution of the acoustic sensor, a pulse length of the acoustic sensor, a pulse width of the acoustic sensor, an operating frequency of the acoustic sensor, a beam scanning mode of the acoustic sensor, a receiver sensitivity of the acoustic sensor, and an acoustic source strength of the acoustic sensor.

15. A system, comprising:
a set of one or more sensors configured to capture a set of data indicative of one or more underwater object parameters corresponding to one or more underwater objects within a marine enclosure;
a digital storage medium, encoding instructions executable by a computing device;
a processor, communicably coupled to the digital storage medium, configured to execute the instructions, wherein the instructions are configured to:
determine a set of intrinsic operating parameters for a sensor system at a position within the marine enclosure based at least in part on the data indicative of one or more underwater object parameters;
configure the sensor system according to the determined set of intrinsic operating parameters by changing at least one intrinsic operating parameter of the sensor system in response to the data indicative of one or more underwater object parameters; and
obtain an underwater object data set in response to configuring the sensor system according to the determined set of intrinsic operating parameters, wherein the underwater object data set includes one or more sensor measurements of the one or more underwater objects within the marine enclosure.

16. The system of claim 15, wherein the processor is further configured to:
change the at least one intrinsic operating parameter of the sensor system without physically repositioning the sensor system away from the position within the marine enclosure.

17. The system of claim 16, wherein the processor is further configured to:
change a pose of the sensor system without physically repositioning the sensor system away from the position within the marine enclosure.

18. The system of claim 15, wherein the processor is further configured to:
receive, data indicative of one or more environmental conditions associated with the marine enclosure; and
determine the set of intrinsic operating parameters for the sensor system based at least in part on the data indicative of one or more environmental conditions.

19. The system of claim 15, wherein the processor is further configured to:
change one or more intrinsic operating parameters including a beam width of an acoustic sensor of the sensor system; an angular resolution of the acoustic sensor, a range resolution of the acoustic sensor, a pulse length of the acoustic sensor, a pulse width of the acoustic sensor, an operating frequency of the acoustic sensor, a beam scanning mode of the acoustic sensor, a receiver sensitivity of the acoustic sensor, and an acoustic source strength of the acoustic sensor.

20. The system of claim 15, wherein the processor is further configured to:
change one or more intrinsic operating parameters including an aperture size of an image sensor of the sensor system, a shutter speed of the image sensor, an ISO value of the image sensor, an exposure setting of the image sensor, a depth of field of the image sensor, an optical zoom of the image sensor; a field of view of the image sensor, changing a lens shift position of the image sensor, and a lens tilt angle of the image sensor.
